(19) United States
(12) Patent Application Publication
(10) Pub. No.: US 2024/0336481 A1
(43) Pub. Date: Oct. 10, 2024

(54) DUAL PRESSURE SYSTEM FOR PRODUCING NITRIC ACID AND METHOD OF OPERATING THEREOF

(71) Applicant: Yara International ASA, Oslo (NO)

(72) Inventors: Bent VIGELAND, Skien (NO); Halvor ØIEN, Porsgrunn (NO); Peter FAUCONNIER, Grimbergen (BE); Andre DE SMET, Terneuzen (NL)

(21) Appl. No.: 18/292,066

(22) PCT Filed: Aug. 25, 2022
(86) PCT No.: PCT/EP2022/073638

§ 371 Date: Jan. 25, 2024

(30) Foreign Application Priority Data
Aug. 25, 2021 (EP) 21193029.2
Jan. 11, 2022 (EP) 22150904.5

(51) Int. Cl. C01B 21/38; B01D 53/00; B01D 53/14; B01D 53/18; C01B 21/28

(52) U.S. Cl. CPC C01B 21/38; B01D 53/002; B01D 53/1456; B01D 53/18; C01B 21/28; B01D 2252/103; B01D 2257/404; B01D 2258/02

(57) ABSTRACT

A system for producing nitric acid at reduced power, the system being a standard dual pressure nitric acid plant further including features for splitting a tail gas stream into a first tail gas stream, in fluid communication with an oxygen-rich gas upstream the ammonia mixing unit, and a second tail gas stream, and features for adjusting the amount of tail gas being split into the first tail gas stream and the second tail gas stream, such that an air compressor is not required for operating the nitric acid plant. A method for operating the system, the use of the system for performing the method and, a method for revamping a standard dual pressure nitric acid plant into the system.

### FIELD

The present disclosure relates to the field of nitric acid production in a dual pressure plant.

### BACKGROUND

Pure nitric acid is a clear, colorless liquid with a strong odor. Nitric acid is produced in large quantities principally by catalytic oxidation of ammonia (Ostwald process). Ammonia is converted to nitric acid in several stages. The ammonia is first oxidized in an ammonia burner on platinum gauzes (commonly called ammonia converter) or cobalt balls, producing nitric oxide (in this disclosure also called nitrogen monoxide (NO)) and water:

4NH₃(g)+5O₂(g)→4NO(g)+6H₂O(g) (1)

The reaction product from (1), nitric oxide, following cooling, is then oxidized to nitrogen dioxide (NO₂) and further to dinitrogen tetroxide N₂O₄ (g) in an oxidation section:

2NO(g)+O₂(g)→2NO₂(g) (2)

2NO₂(g)→N₂O₄(g) (3)

Cooling of nitrogen oxide gases is accomplished first through the use of a waste heat recovery system recovering the heat from the conversion of ammonia into nitric oxide, then through the use of a cooler condenser in which condensed nitric acid is separated from nitric oxide, nitrogen dioxide and dinitrogen tetroxide and nitric acid gases, collectively called NOₓ gases, and finally by heating the tail gas released at the outlet of the absorption tower in which the NOₓ gases are absorbed.

By absorption in water, following compression through a NOₓ gas compressor, nitrogen dioxide and dinitrogen tetroxide are converted to nitric acid and nitric oxide:

3NO₂(g)+H₂O(I)+2HNO₃(aq)+NO(g) (4)

3N₂O₄(g)+2H₂O(I)+4HNO₃(aq)+2NO(g) (5)

Weak nitric acid which is up to 68% (azeotrope) is obtained. Through a rectification process the concentration of nitric acid can be increased up to 99% concentrated nitric acid. The total reaction is given by the following formula:

NH₃+2O₂→HNO₃+H₂O (6)

The main process units in a nitric acid production plant, include an ammonia converter (conversion of ammonia into nitric oxides using oxygen over a suitable catalyst), an oxidation section (conversion of nitric oxide into nitrogen dioxide and nitrogen tetroxide), an absorber unit (for the absorption of NOₓ gases into water) and a bleacher unit (removal of unreacted dissolved gases, containing in particular NOₓ and gases, from the aqueous nitric acid solution, which give it its typical brownish color).

The process for the production of nitric acid can be differentiated into a mono pressure (single-pressure) and dual pressure (split-pressure) process.

In a dual pressure process, the absorber unit operates at a higher working pressure than the ammonia converter. Modern dual pressure processes feature a low-pressure ammonia converter operating typically at 2 to 6 bara, and a high-pressure absorber unit operating at 9 to 16 bara.

A dual pressure process requires an air compressor to feed low-pressure air (which comprises about 21 vol % of oxygen) to the converter, and a NOₓ gas compressor to feed high-pressure NOₓ gases to the absorber unit. The working pressure of an air compressor is from 2 to 6 bara, inclusive, and the working pressure of a NOₓ gas compressor is from 9 to 16 bara, inclusive.

The drive power for the air compressor typically originates from a tail gas turbine and a steam turbine or a power source such as an electric motor. Accordingly, the compressor train of a dual pressure nitric acid production plant typically comprises an air compressor, a NOₓ gas compressor, a tail gas turbine, and a steam turbine or a power source such as an electric motor.

More in detail, referring to FIG. 1, a dual pressure plant and process according to the prior art works as follows. Gaseous ammonia 32, optionally pre-heated in a pre-heater unit (not shown) is mixed with compressed air 34 pressurized to a low pressure using an air compressor 36, in a mixing apparatus 35, and the resulting ammonia/oxygen-enriched air mixture 14 is fed to an ammonia converter 37, operating at a low pressure, where ammonia is oxidized over a suitable catalyst, thus obtaining a LP NOₓ gas/steam mixture 15, comprising water and nitric oxide (NO). The heat of the mixture coming out of the ammonia converter is recovered, after which the NOₓ gas/stream mixture is subsequently cooled down in a gas cooler/condenser 38 to temperature where the water condenses, and an aqueous diluted nitric acid mixture 17 is separated from a gaseous NOₓ stream 22. The gaseous NOₓ stream 22 is sent to a NOₓ gas compressor 40 wherein its pressure is elevated from a low pressure to a high pressure, being about equal to an absorber unit, 41, operating pressure, and the pressurized gaseous NOₓ stream 24 is sent to the absorber to the absorber unit 41, commonly called absorption tower. The pressurized NOₓ gas stream 24 is further oxidized to further convert the NO to NO₂ and N₂O₄, cooled in an additional gas cooler/condenser 39 and then directed to the absorption tower 41 too. Inside the absorption tower 41, the pressurized NOₓ gas stream 24 reacts with water to produce the tail gas 5 and a stream of raw nitric acid 27 also containing residual NOₓ gas, which is fed to a bleacher 62. The residual NOₓ gas in the raw nitric acid stream 27 is then stripped out with a gaseous medium 72 such as an oxygen-containing gas or air, inside the bleacher unit 62 operating at low-pressure; the bleacher unit is generally operated at about the same pressure as the ammonia converter. The drive power for both the air compressor 36 and the NOₓ gas compressor 40 originates from a tail gas expander 7 and a steam turbine 51 or a power source such as an electric motor (not shown). The heat generated in the ammonia converter 37 is used for heating the tail gas 5 in the tail gas heat exchanger 43 comprising the heat exchangers 66 and 67, the tail gas heater being therefore optionally present. The tail gas 5 exchanges heat with the NOₓ gas/steam mixture 15 in the heat exchange system 43 and is expanded in the tail gas expander 7.

The air used for the oxidation of ammonia is commonly denoted as primary air; the air used as stripping medium in the bleacher unit is commonly denoted as secondary air.

According to the prior art, the revamping of the nitric acid production plants to increase its capacity is commonly based on increasing the amount of primary air to the reactor, which leads to a proportional increase of the amount of nitric acid produced.

The increase of the amount of primary air in the reactor entails the installation of a new air compressor or the revamping of the existing one. The increase of the primary air also causes a higher amount of gas to be processed subsequently into the NOₓ gas compressor. This entails the further revamping of the NOₓ gas compressor or the installation of a new one, and the modification or replacement of the tail gas and/or the steam-turbines and/or the electrical motor. Otherwise, the NOₓ gas compressor would easily achieve its process limit, thus becoming the bottleneck of the plant.

However, the revamping has significant drawbacks. First of all, it entails elevated costs for the modification or replacement of the existing equipment, i.e. the air compressor, the NOₓ gas compressor and the corresponding turbines and electrical motor. In addition, the revamping of the equipment is also technically demanding leading to long plant downtime.

Another problem related to nitric acid production plants is the high amount of energy required in order to operate the air compressor. Consequently, a high amount of energy is required to achieve the targeted nitric acid production throughput.

A goal of the present invention, therefore, is to provide a system and a method for operating the system which allows for the reduction or even suppression of power required to operate the air compressor in a dual nitric acid plant.

In CN110540178A (China Chengda Engineering Co Ltd, 2019), process for producing nitric acid is disclosed. Nitric acid is produced by a medium pressure method, which is characterized in that it comprises the following steps: the ammonia oxidation and absorption pressure is 0.5-0.6 MPa; enabling the tail gas leaving the absorption tower to pass through a carbon molecular sieve Temperature Swing Adsorption (TSA) treatment device to reduce the content of nitrogen oxides in the tail gas to be less than 100 mg/Nm³; the process air of the air compressor is used as the regeneration desorption gas of the carbon molecular sieve temperature swing adsorption treatment device, and the regeneration desorption gas containing the nitrogen oxide can be returned to the ammonia oxidation reactor for reuse; adding a layer of N₂O decomposition catalyst in the oxidation reactor to reduce the content of N₂O to 50-100 PPM through reaction; the nitric acid bleaching tower is arranged at the bottom of the absorption tower, and the two towers are integrated, so that the process flow is shortened, and the equipment investment is reduced. With regard to the amount of air being compressed by the air compressor, however, the same amount of air is to be compressed as would be in the absence of the TSA unit: in the presence of the TSA unit, the amount of air being compressed is initially split between the TSA unit and the ammonia oxidation reactor directly and, in the end, with the amount of compressed air leaving the TSA unit being directed also to the ammonia oxidation reactor, the total amount of air compressed by the air compressor ends up in the ammonia oxidation reactor.

In WO2018/162150A1 (Casale S A, 13 Sep. 2018) a solution is proposed to overcome the revamping drawbacks. WO2018162150A1 discloses a dual pressure plant for the production of nitric acid comprising a reactor providing a gaseous effluent containing nitrogen oxides, an absorber unit in which nitrogen oxides react with water providing raw nitric acid and, the absorber unit operating at a pressure greater than the pressure of the reactor, a compressor elevating the pressure of the reactor effluent to the absorber unit pressure, the plant also comprising a first HP bleacher unit and a second LP bleacher unit, the first HP bleacher unit stripping with air the NOₓ gas from the output stream of the absorber unit, thus providing a partially stripped nitric acid stream and a nitrogen oxides-loaded air stream, the former being fed to the second LP-bleacher unit and the latter being recycled to the oxidation section, upstream of the NOₓ gas compressor.

A further air compressor is also provided, which supplies the first HP bleacher unit with air. Hence, energy is required in order to operate a first HP bleacher unit at a high-pressure and then recycle NOₓ gases to the delivery side of the NOₓ gas compressor.

Therefore, there remains a need for a process and a corresponding plant setup for minimizing or even suppressing the amount of energy required in order to operate the NOₓ gas compressor and, preferably, also the air compressor, in order to avoid bottle-necks in the nitric acid production throughput associated with those compressors.

### SUMMARY

In one aspect of the disclosure, a production plant for producing nitric acid at reduced power consumption and reduced emissions, comprising, optionally, a source of pressurized air in fluid communication with the production plant, is disclosed. The system comprises:
a source of an oxygen-rich gas, particularly a source of pressurized oxygen-rich gas, such as a high pressure water electrolyzer;
a mixing apparatus downstream the source of oxygen-rich gas, for mixing a first oxygen-containing gas with an ammonia gas stream, to produce an ammonia/oxygen-containing gas mixture;
an ammonia converter, particularly operable at a pressure equal to or higher than P1 and lower than P2, for oxidizing ammonia in the ammonia/oxygen-containing gas mixture, to produce a NOₓ gas/steam mixture comprising water and nitric oxide;
a means for regulating the concentration of ammonia and/or of oxygen in the ammonia converter, particularly a means for controlling the flow of the oxygen-rich gas and/or a means for controlling the flow of the ammonia gas stream, for maintaining the oxygen to ammonia molar ratio inside the ammonia converter at a ratio of at least 1.2;
a first gas cooler/condenser downstream the ammonia converter, to produce an aqueous diluted nitric acid mixture and a gaseous NOₓ stream;
a NOₓ gas compressor for compressing the gaseous NOₓ stream, to produce a compressed NOₓ gas stream at a pressure P2;
an absorption tower for absorbing the NOₓ gases from the compressed NOₓ gas stream in water, to produce a stream of raw nitric acid containing residual NOₓ gas, and a tail gas comprising NOₓ gases, comprising an absorption tower tail gas outlet for evacuating the tail gas;
a heat exchange system located upstream the gas cooler/condenser for exchanging heat between the NOₓ gas/steam mixture and the tail gas, in particular for heating a tail gas stream with the heat from the NOₓ gas/steam coming from the ammonia converter;
a second gas cooler/condenser for separating and condensing steam from the compressed NOₓ gas stream, particularly before the compressed NOₓ gas stream is provided to the absorption tower.
a supply for a second oxygen-containing gas having either (i) a pressure equal to or higher than P1 and up to Pc, for supplying oxygen downstream the ammonia converter and upstream the NOₓ gas compressor, or (ii) a pressure higher than P2, for supplying oxygen to the compressed NOₓ gas stream,
a means for controlling the flow of the second oxygen-containing gas, such that a tail gas stream contains at least 0.5% by volume oxygen; and
a first pressure release means, in particular tail gas expander, located downstream the heat exchange system, for expanding a stream of tail gas downstream the absorption tower, to produce a first expanded tail gas at a pressure equal to or higher than P1 and lower than P2, wherein the first pressure release means, in particular the tail gas expander, can at least partly power the NOₓ gas compressor;
   characterized in that the production plant further comprises:
a means for splitting a tail gas into a first tail gas stream and a second tail gas stream, wherein the first tail gas is in fluid communication with the oxygen-rich gas, particularly wherein the first tail gas stream has a pressure equal to or higher than P1 and up to P2, and wherein the mixing of the oxygen-rich gas and the first tail gas stream provides the first oxygen-containing gas.

The inventors have found that, instead of continuously supplying compressed air provided by an air compressor as primary air to the mixing unit, it is possible to recirculate the first tail gas stream provided by the means for splitting at a pressure P1, particularly when combined with, at the same time, providing oxygen, particularly pressurized oxygen, to the system. Therefore, compressed or pressurized air only has to be supplied in order to start the process, in particular to pressurize the plant or system at startup, but no longer after the production of the tail gas has started. An air compressor is thus not required for operating the nitric acid plant. In this context, an air compressor suitable for pressurizing the plant has a capacity of about 2,000 to 19,000 m³/h, which is much smaller than an air compressor for operating a prior art nitric acid plant, with a capacity of at least 300,000 m³/h. In a dual pressure nitric acid plant, the tail gas has a pressure higher than P1 and, therefore, a first pressure release means, such as the tail gas expander, can be used to expand a tail gas stream to a pressure P1. In addition, a first oxygen-rich gas having a pressure equal to or higher than P1 and up to P2 and a second oxygen-rich gas having a pressure higher than P2, provide oxygen to the ammonia converter and to the absorption tower, respectively, such that, in the absence of the primary and secondary air provided by the air compressor, the concentration of oxygen in the ammonia converter and in the absorption tower is similar to that in a standard dual pressure nitric acid plant.

In the absence of an air compressor and with the first tail gas stream being recirculated in the system, not only is the power demand of the system reduced, but the NOₓ emissions leaving the system are also reduced. Therefore, the size of the treatment unit for treating those NOₓ emissions is reduced with respect to the size in the corresponding standard dual pressure nitric acid plant. The system of the present disclosure thus achieves a significant power reduction together with a reduction of the area footprint of the plant and the simplification of the system, by the removal of the air compressor and reducing the size of the tail gas expander. In addition, the separate supply of the pressurized oxygen or oxygen-rich gas ensures an optimal conversion of ammonia to nitric oxide.

In one embodiment according to the production plant of the disclosure, the system further comprises one or more of:
a steam turbine, wherein the steam turbine can at least partly power the NOₓ gas compressor;
a heat exchanger for exchanging heat between the first expanded tail gas and a colder tail gas stream, wherein the first expanded tail gas exits the heat exchanger particularly at a temperature below 300° C., and wherein the means for splitting is positioned downstream the heat exchanger and in fluid communication with the first expanded tail gas;
a De-NOₓ treatment unit; and
a second pressure release means for expanding the second tail gas stream to atmospheric pressure, to produce a second expanded tail gas.

In one embodiment according to the production plant of the disclosure, the system further comprises a bleacher for bleaching the stream of raw nitric acid-containing residual NOₓ gas, to provide a stream of bleached nitric acid, having an inlet for an oxygen-rich bleaching gas, and an outlet for off-gases in fluid communication with any gas stream downstream the ammonia converter and upstream the NOₓ gas compressor if the bleacher operates at a pressure equal to or higher than P1 and up to equal to P2, or in fluid communication with any stream downstream the NOₓ gas compressor and upstream the absorption tower if the bleacher operates at a pressure higher than P2, such that the supply for the second oxygen containing gas comes at least partly from the off-gases.

In one embodiment according to the production plant of the disclosure, part of the oxygen-rich gas or part of the first oxygen-containing gas or part of the tail gas, is in fluid communication with the inlet of the bleacher, such that the oxygen rich-bleaching gas is at least partly provided by part of the oxygen-rich gas by part of the first oxygen-containing gas or by part of a tail gas stream.

In one embodiment according to the production plant of the disclosure, the system further comprises a stream of a second oxygen-containing gas in direct fluid communication with any tail gas stream, particularly a stream of pressurized oxygen-rich gas in direct fluid communication with any stream of tail gas downstream the absorption tower or upstream the first pressure release means.

In one embodiment according to the production plant of the disclosure, the oxygen-rich gas, the second oxygen-containing gas, the oxygen-rich bleaching gas and the bleacher off-gases are all at least partly provided by a water electrolyzer, particularly a high pressure water electrolyzer.

In one embodiment according to the production plant of the disclosure, the fluid communication between the source of pressurized air and the system is in direct fluid communication with the oxygen-rich gas.

In one aspect of the disclosure, a method for producing nitric acid at reduced power consumption and reduced emissions, in a production plant according to the production plant of the disclosure, is disclosed. The method comprises the steps of:
prior to step c), providing or preparing an oxygen-rich gas and a first oxygen-containing gas, and providing an ammonia gas stream;
c) supplying the ammonia gas stream and a first oxygen-containing gas to the mixing apparatus, thereby producing the ammonia/oxygen-containing gas mixture;
d) oxidising ammonia in the ammonia/oxygen-containing gas mixture in the ammonia converter, particularly at a pressure equal to or higher than P1 and lower than P2 and at a temperature ranging from 800 to 950° C., thereby producing the gaseous NOₓ gas/steam mixture, comprising water and nitric oxide;
e) cooling the NOₓ gas in the gaseous NOₓ gas/steam mixture in the heat exchange system and in the first gas/cooler condenser, thereby producing an aqueous diluted nitric acid mixture and a gaseous NOₓ stream;
f) compressing the gaseous NOₓ stream in the NOₓ gas compressor, thereby providing the pressurized NOₓ compressed gas stream having a pressure P2;
g) absorbing the pressurized gaseous NOₓ stream in the absorption tower, thereby providing the stream of raw nitric acid-containing residual NOₓ gas and the tail gas comprising NOₓ gases;
h) heating the tail gas in the heat exchange system, with the heat from the NOₓ gas/steam mixture coming from the ammonia converter, particularly to a temperature ranging from 150 to 650° C.;
i) cooling the pressurized NOₓ gas stream in the second gas cooler/condenser, thereby providing a pressurized NOₓ gas stream, particularly having a temperature ranging from 20 to 60° C.; and
j) expanding at least part of the tail gas obtained in step h) in a first pressure release means, thereby providing a first expanded tail gas;
   characterized in that the method further comprises the steps of:
k) splitting a tail gas stream with a first means for splitting into a first tail gas stream and a second tail gas stream, and mixing the first tail gas stream with the oxygen-rich gas, thereby providing the first oxygen-containing gas;
m) adjusting the flow of the oxygen-rich gas being mixed in step k) or the flow of the ammonia gas stream, such that the oxygen to ammonia molar ratio at the inlet of the ammonia converter is maintained to a ratio of at least 1.2 or at least 1.25, particularly between 1.2 and 9 or between 1.25 and 9; and
q) adjusting the flow of the oxygen-rich gas at a pressure equal to or higher than P1 and up to P2 upstream the NOₓ gas compressor, or at a pressure higher than P2 downstream the NOₓ gas compressor, such that the oxygen concentration in a tail gas stream is maintained at a concentration of at least 0.5% by volume; In one embodiment according to the method of the disclosure, the first tail gas stream, particularly first expanded tail gas stream, mixed in step k) is particularly obtained after step j), and wherein the method further comprises the steps of:
s) particularly before step k), heating up, in the heat exchanger, a tail gas stream that is colder than the first expanded tail gas with the first expanded tail gas, thereby bringing the first expanded tail gas to a temperature below 300° C., in particular before step k), heating up, in the heat exchanger the tail gas obtained in step g) with the first expanded tail gas obtained in step j), thereby bringing the tail gas to be mixed in step k) to a temperature below 300° C.;
t) treating the tail gas stream, particularly obtained in step s, in the De-NOₓ treatment unit;
u) expanding the second tail gas stream in the second pressure release means, thereby providing the second expanded tail gas; and
v) recovering at least part of the steam generated in the ammonia converter in the steam turbine.
In one embodiment according to the method of the disclosure, the method further comprises the step of:
w) bleaching the stream of raw nitric acid-containing residual NOₓ gas in the bleacher, thereby producing the stream of bleached nitric acid.

In one embodiment according to the method of the disclosure, the method further comprises the step of:
w1) supplying part of the oxygen-rich or part of the first oxygen-containing gas obtained in step k) or part of the tail gas obtained in step g), to the inlet of the bleacher in step w).

In one embodiment according to the method of the disclosure, the method further comprises the step of:
x) supplying a stream of an oxygen-rich gas, particularly as a stream of a pressurized oxygen-rich gas, to a tail gas stream, particularly to a tail gas stream upstream the first pressure release means

In one embodiment according to the method of the disclosure, the method further comprises the steps of:
y) operating the water electrolyzer, thereby producing oxygen-gas, particularly operating a high pressure water electrolyzer, thereby producing pressurized oxygen gas; and
z) providing, from the oxygen produced by the water electrolyzer in step y), at least part of the oxygen-rich gas, the second oxygen containing gas, the oxygen-rich bleaching gas, and the bleacher off gases.

In one embodiment according to the method of the disclosure, in step a), the pressurized air is supplied in the stream in direct fluid communication with the oxygen-rich gas.

In one aspect of the disclosure, the use of the production plant of the disclosure for performing the method of the disclosure, is disclosed.

In one aspect of the disclosure, a method for revamping an (existing) production plant for producing nitric acid, wherein the (existing) production plant comprises:
an air compressor for providing a compressed air stream;
a mixing apparatus, for mixing the compressed air stream with an ammonia gas stream, to produce an ammonia/oxygen-containing gas mixture;
an ammonia converter operable at a pressure equal to or higher than P1 but lower than P2, for oxidising ammonia in the ammonia/oxygen-containing gas mixture, to produce a NOₓ gas/steam mixture, comprising water and nitric oxide;
a first gas cooler/condenser, downstream the ammonia converter, to produce an aqueous diluted nitric acid mixture, and a gaseous NOₓ stream;
a NOₓ gas compressor for compressing the gaseous NOₓ stream, to produce a pressurized NOₓ gas stream at a pressure P2;
an absorption tower for absorbing the NOₓ gases from the pressurized NOₓ gas stream in water, to produce a stream of raw nitric acid-containing residual NOₓ gas and a tail gas comprising NOₓ gases;
a heat exchange system for exchanging heat between the NOₓ/gas steam mixture and the tail gas, particularly for heating a tail gas stream with the heat from the NOₓ gas/steam mixture from the ammonia converter;
a second gas cooler/condenser for separating and condensing steam from the compressed NOₓ gas stream between the NOₓ compressor and the absorption tower, and
a tail gas expander for expanding a stream of tail gas downstream the absorption tower, to produce an expanded tail gas at a pressure P1, wherein the tail gas expander can at least partly power the NOₓ gas compressor;
   into a production plant according to any one of claims 1 to 8, comprising the steps of:
introducing a source of pressurized air in fluid communication with the production plant;
introducing a supply or source of an oxygen-rich gas, such as a high pressure water electrolyzer, providing part of a first oxygen-containing gas, upstream of and in fluid communication with the mixing apparatus;
introducing a means for regulating the concentration of ammonia and/or oxygen in the ammonia converter, particularly a means for controlling the flow of the oxygen-rich gas or the flow of the first oxygen-containing gas and/or a means for controlling the flow of the ammonia gas stream, for maintaining the oxygen to ammonia molar ratio inside the ammonia converter at a ratio of at least 1.2 or at least 1.25, particularly between 1.2 and 9 or between 1.25 and 9;
introducing a supply of a second oxygen-containing gas, having either (i) a pressure equal to or higher than P1 and up to P2 for supplying oxygen upstream the NOₓ gas compressor, or (ii) a pressure higher than P2, for supplying oxygen to the compressed NOₓ gas stream, such that a tail gas stream contains at least 0.5% by volume of oxygen;
introducing means for splitting a stream of tail gas into a first tail gas stream and a second tail gas stream, wherein the first tail gas stream has a pressure equal to or higher than P1 and up to P2, and is in fluid communication with the oxygen-rich gas, which, upon mixing with the oxygen-rich gas provides the first oxygen-containing gas;
particularly, introducing means for adjusting the amount of tail gas being split into the first tail gas stream and the second tail gas stream; and
removing the air compressor.

### BRIEF DESCRIPTION OF THE FIGURES

FIG. 1: Nitric acid plant according to the prior art.

FIG. 2A: An embodiment of a nitric acid plant according to the disclosure, wherein the second oxygen containing gas stream 68 has a pressure equal to or higher than P1 and lower than P2, and is provided upstream the NOₓ gas compressor.

FIG. 2B: An embodiment of a nitric acid plant according to the disclosure, comprising a low pressure bleacher, in particular with a pressure equal to or higher than P1 and up to P2, wherein the bleacher off-gases 77 are provided upstream the NOₓ gas compressor.

FIG. 2C: An embodiment of a nitric acid plant according to the disclosure, wherein the second oxygen containing gas stream 68 has a pressure equal to or higher than P2, and is provided downstream the NOₓ gas compressor, between the NOₓ gas compressor and the absorber.

FIG. 2D: An embodiment of a nitric acid plant according to the disclosure, comprising a high-pressure bleacher, in particular with a pressure equal to or higher than P2, wherein the bleacher off-gases 77 are provided downstream the NOₓ gas compressor, between the NOx gas compressor and the absorber.

Table of numerals

| | |
|---|---|
| 4 | air |
| 5 | tail gas |
| 6 | outlet of nitric acid absorption tower |
| 7 | a first pressure release means (tail gas expander) |
| 10 | first tail gas stream |
| 14 | ammonia/oxygen-containing gas mixture |
| 15 | low-pressure NOₓ gas/steam mixture |
| 17 | aqueous diluted nitric acid mixture |
| 22 | gaseous NOₓ stream |
| 24 | compressed NOₓ gas |
| 27 | stream of raw nitric acid-containing residual NOₓ gas |
| 32 | ammonia |
| 34 | compressed or pressurized air (prior art) |
| 35 | mixing apparatus |
| 36 | air compressor |
| 37 | ammonia converter operable at a pressure equal to or lower |
| | than P1 |
| 38 | gas cooler/condenser |
| 39 | additional gas cooler/condenser |
| 40 | NOx gas compressor, particularly for compressing a gas to a |
| | pressure P2 higher than P1 |
| 41 | absorption tower |
| | operable at a pressure P2 |
| 43 | heat exchange system |
| 50 | oxygen-rich gas |
| 51 | steam turbine |
| 55 | means for splitting the tail gas |
| 56 | first oxygen-containing gas |
| 60 | second pressure release means |
| 61 | pressurized oxygen-rich gas |
| 62 | bleacher |
| 63 | high-pressure water electrolyzer |
| 64 | expanded tail gas |
| 65 | pressurized air (production plant according to the present |
| | disclosure) |
| 66 | first heat exchanger of the heat exchange system 43 |
| 67 | second heat exchanger of the heat exchange system 43 |
| 68 | second oxygen containing gas |
| 69 | second expanded tail gas |
| 70 | De-NOₓ treatment unit |
| 72 | oxygen-rich bleaching gas |
| 73 | outlet of the bleacher |
| 74 | stream of an oxygen-rich gas in direct fluid communication |
| | with a tail gas stream |
| 75 | bleached nitric acid |
| 77 | off gases from the outlet 73 of the bleacher 62 |
| 78 | means for pressurizing |
| 79 | heat exchanger |
| 80 | second tail gas stream |
| 83, 84 | tail gas stream partly substituting a source of secondary air |

### DETAILED DESCRIPTION

Throughout the description and claims of this specification, the words “comprise” and variations thereof mean “including but not limited to”, and they are not intended to (and do not) exclude other moieties, additives, components, integers or steps. Throughout the description and claims of this disclosure, the singular encompasses the plural unless the context otherwise requires. In particular, where the indefinite article is used, the disclosure is to be understood as contemplating plurality as well as singularity, unless the context requires otherwise.

Features, integers, characteristics, compounds, chemical moieties, or groups described in conjunction with a particular aspect, embodiment or example of the disclosure are to be understood to be applicable to any other aspect, embodiment or example described herein unless incompatible therewith. All of the features disclosed in this disclosure (including the description, claims, abstract and drawing), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this disclosure (including the description, claims, abstract and drawing), or to any novel one, or any novel combination, of the steps of any method or process so disclosed.

The enumeration of numeric values by means of ranges of figures comprises all values and fractions in these ranges, as well as the cited end points. The terms “ranging from . . . to . . . ” or “range from . . . to . . . ” or “up to” as used when referring to a range for a measurable value, such as a parameter, an amount, a time period, and the like, is intended to include the limits associated to the range that is disclosed.

Where the term “about” when applied to a particular value or to a range, the value or range is interpreted as being as accurate as the method used to measure it.

As defined herein, an oxygen-rich gas is a gas comprising more than 21 vol % of oxygen, more in particular more than 30 vol %, more than 35 vol %, more than 40 vol %, more than 50 vol %, more than 60 vol %, more than 70 vol %, more than 80 vol %, more than 90 vol %, more than 95 vol %, more than 98 vol % and more than 99 vol %, more in particular 100 vol % of oxygen. Such oxygen-rich gas can, for example, be provided by an air separation unit or a water electrolyzer.

As defined herein, a pressurized oxygen-rich gas is a gas having a pressure ranging from 9 to 30 bara, preferably 15 to 30 bara, and comprising more than 21 vol % of oxygen, more in particular more than 30 vol %, more than 35 vol %, than 40 vol %, more than 50 vol %, more than 60 vol %, more than 70 vol %, more than 80 vol %, more than 90 vol %, more than 95 vol %, more than 98 vol %, and more than 99 vol %, more in particular 100 vol % of oxygen.

As defined herein, air is ambient air having atmospheric pressure.

As defined herein, steam are water vapors.

As defined herein, the term “flow” refers to either a volumetric flow or a mass flow.

The present disclosure generally relates to dual pressure methods and systems for producing nitric acid, which typically operates at two pressures, P1 and P2. Typically, P1 ranges from 2 to below 6 bara and P2 ranges from 6 to 16 bara.

The present disclosure generally relates to a dual pressure system and method for the production of nitric acid with important gains compared to conventional systems and methods, wherein the conventional primary air and/or secondary air consisting of pressurized air, provided by an air compressor with a typical capacity of at least 300,000 m³/h, is replaced by the combination of (i) oxygen gas or an oxygen-rich gas, in particular a pressurized oxygen gas or oxygen-rich gas, such as produced by a high pressure water electrolyzer as further discussed herein; and (ii) a recirculated tail gas stream, thus removing the need for an air compressor to generate compressed primary and/or secondary air. Stated differently, in the system and methods for the production of nitric acid according to the present disclosure:
(i) oxygen gas or an oxygen-rich gas, in particular a pressurized oxygen gas or oxygen-rich gas, such as produced by a high-pressure water electrolyzer, is used (a) upon mixing with part of the tail gas stream, to provide a first oxygen-containing gas stream, which is mixed with an ammonia gas stream and subsequently provided to the ammonia converter; and (b) is used to provide a second oxygen-containing gas stream downstream of the ammonia converter, such as a second oxygen-containing gas stream which is mixed with a NOₓ containing gas stream downstream of the ammonia converter, such as between the ammonia converter and NOx compressor or between the NOₓ compressor and the absorber, and/or which is used as a stripping gas in a bleacher, wherein, in particular, the oxygen containing bleacher off-gases are subsequently mixed with a NOₓ containing gas stream between ammonia converter and absorber; and
(ii) the tail gas exiting the absorber is split in a first tail gas stream and a second tail gas stream, wherein the first tail gas stream is mixed with the oxygen gas or the oxygen-rich gas, in particular the pressurized oxygen or oxygen-rich gas, such as produced by a high pressure water electrolyzer, to provide the first oxygen-containing gas stream; and/or wherein part of the tail gas exiting the absorber may also be mixed with the oxygen gas or oxygen-rich gas, or the first oxygen containing gas, in particular the pressurized oxygen gas or oxygen-rich gas, such as produced by a high-pressure water electrolyzer, to provide the second oxygen containing gas stream.

### Nitric Acid Production Plant

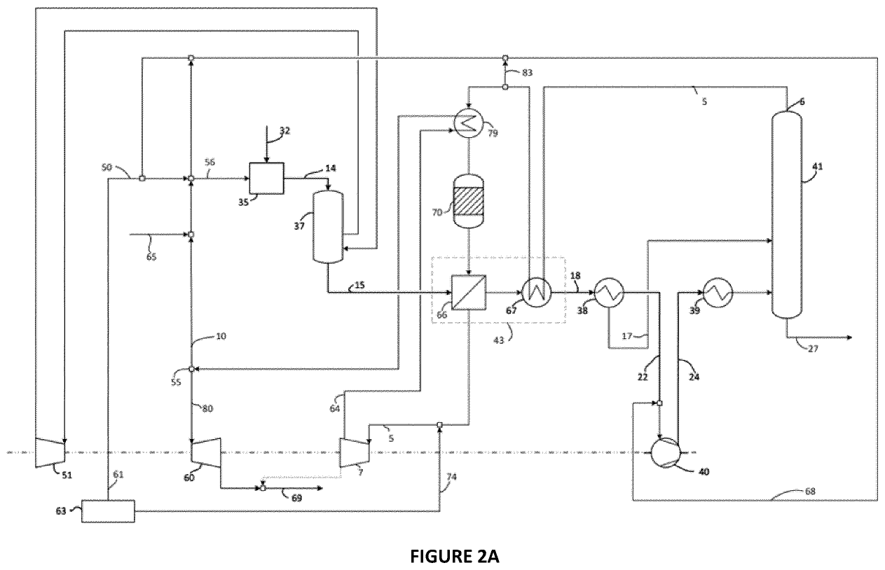

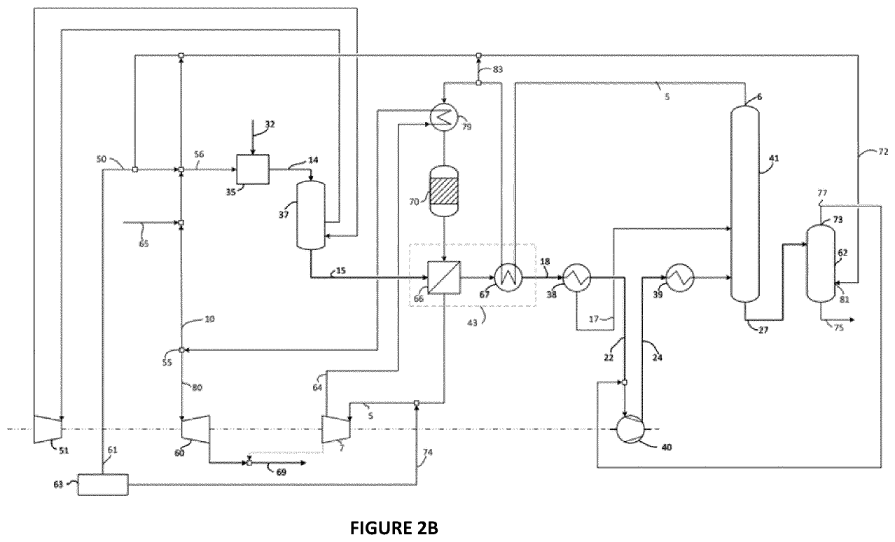

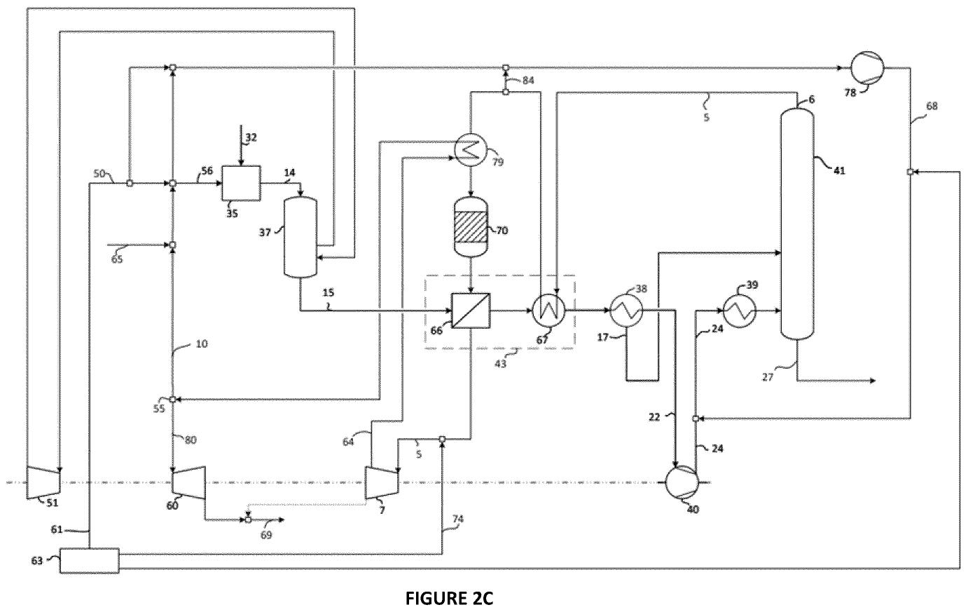

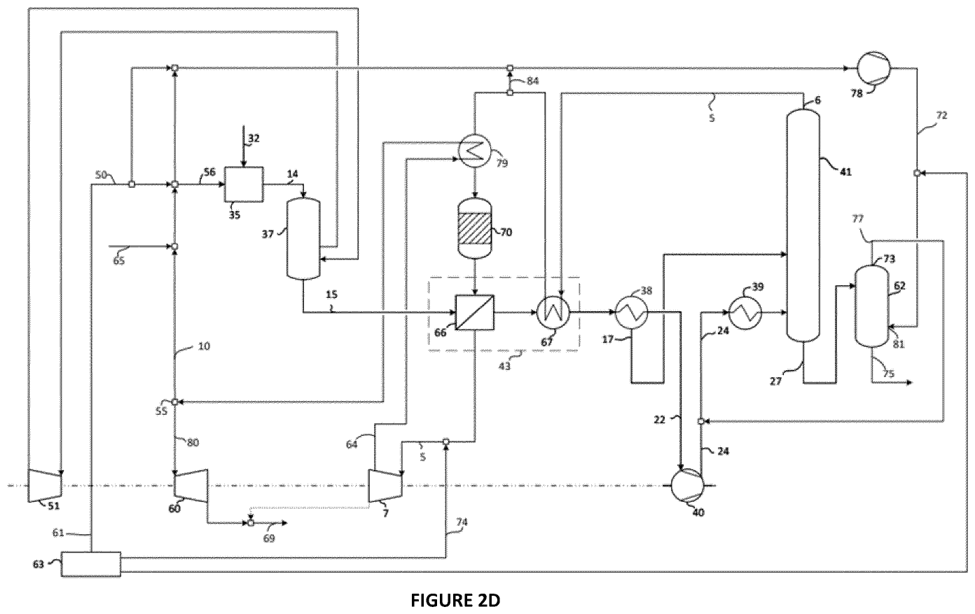

Reference is made to FIGS. 2A, 2B, 2C and 2D. In one aspect of the disclosure, a production plant for producing nitric acid at reduced power consumption and reduced emissions, is disclosed. The production plant comprises:
preferably, a source of pressurized air 65, particularly for pressurizing the production plant or system during start-up. More in particular, the source of pressurized air is in fluid communication with a system comprising a source or supply of an oxygen rich gas 50. As defined herein, a source of pressurized air is capable of providing from 2,000 to 19,000 m³/h of pressurized air;
a source or supply of an oxygen-rich gas 50, which provides part of a first oxygen-containing gas;
a mixing apparatus 35 downstream the source or supply of the oxygen-rich gas 50, for mixing a first oxygen-containing gas 56 with an ammonia gas stream 32, to produce an ammonia/oxygen-containing gas mixture 14;
an ammonia converter 37, particularly operable at a pressure equal to or higher than P1 and lower than P2, more particularly operable at a pressure P1, for oxidising ammonia in the ammonia/oxygen-containing gas mixture 14, to produce a NOₓ gas/steam mixture 15, comprising water and nitric oxide;
preferably, a means for measuring the oxygen concentration in the first oxygen-containing gas 56; and preferably, a means for adjusting the supply of the ammonia gas stream 32 to the mixing apparatus 35; and, preferably, a means for adjusting the concentration of oxygen in the oxygen-containing gas 56 such that the oxygen to ammonia molar ratio at the inlet of the ammonia converter 37 is at least 1.2 or at least 1.25, particularly between 1.2 and 9, or between 1.25 and 9. The system according to the present disclosure may thus comprise a means for regulating (not shown) the concentration of ammonia and/or oxygen in the ammonia converter 37, particularly a means for controlling the flow of the oxygen-rich gas 50 and/or a means for controlling the flow of the ammonia gas stream 32, for maintaining the oxygen to ammonia molar ratio inside the ammonia converter 37 at a ratio of at least 1.2 or at least 1.25; such as between 1.2 and 9, between 1.25 and 9 or between 1.3 and 9;
preferably, a means for measuring the temperature in the ammonia converter 37;
a first gas cooler/condenser 38 downstream the ammonia converter 37, to produce an aqueous diluted nitric acid mixture 17 and a gaseous NOₓ stream 22;
a NOₓ gas compressor 40 for compressing the gaseous NOₓ stream 22, to produce a compressed NOₓ gas stream 24 at a pressure P2;
an absorption tower 41 for absorbing the NOₓ gases from the compressed NOₓ gas stream 24 in water, to produce a stream of raw nitric acid-containing residual NOₓ gas 27 and a tail gas 5 comprising NOₓ gases, comprising an absorption tower tail gas outlet 6 for evacuating the tail gas 5;
preferably, a means for measuring the concentration of oxygen in a tail gas stream downstream the absorption tower 41;
a heat exchange system 43 located upstream the first gas cooler/condenser 38 for exchanging heat between the NOₓ gas/steam mixture 15 and the tail gas 5, particularly for heating a tail gas stream with the heat from the NOₓ gas/steam mixture 15;
a second gas cooler/condenser 39 for separating and condensing steam from the compressed NOₓ gas stream 24, particularly before said stream is provided to the absorption tower, particularly to produce a compressed NOₓ gas stream 24 having a temperature ranging from 20 to 60° C.;
a supply of an oxygen-rich gas 68, 72, 77 having either (a) a pressure equal to or higher than P1 and up to P2 (see FIGS. 2A and 2B), for supplying oxygen downstream the ammonia converter 37 and upstream the NOₓ gas compressor 40, or stated differently between the ammonia converter 37 and the NOₓ gas compressor 40, or (b) a pressure higher than P2 (see FIGS. 2C and 2D), for supplying oxygen to the compressed NOₓ gas stream 24, such that a tail gas stream 5, 10, 64, 69, 80, 83, 84 contains at least 0.5% by volume oxygen. In particular, the system may further comprise a means for controlling the flow of the second oxygen containing gas in order to obtain a tail gas stream 5, 10, 64, 69, 80, 83, 84 containing at least 0.5% by volume oxygen; and
a first pressure release means, such as a tail gas expander 7, located downstream the heat exchange system 43, for expanding a stream of tail gas, i.e. downstream the absorption tower 41, to produce a first expanded tail gas 64 at a pressure equal to or higher than P1 and lower than P2, particularly at a pressure P1, wherein the first pressure release means 7 can at least partly power the NOₓ gas compressor 40;

The production plant is characterized in that the system further comprises a means for splitting 55 a stream of tail gas (downstream the absorption tower 41) into a first tail gas stream 10 and a second tail gas stream 80, wherein the first tail gas stream 10 has a pressure equal to or higher than P1 and up to P2 and is in fluid communication with the oxygen-rich gas 50, and optionally the compressed air, wherein the mixing of the oxygen-rich gas 50 and the first tail gas stream 10 provides the first oxygen-containing gas 56. In particular, the production plant may further comprise a means for adjusting the amount of tail gas being split into the first tail gas stream 10 and the second tail gas stream 80.

Typically, the heat exchange system 43 comprises at least two heat exchangers 66, 67. The person skilled in the art will realize that it is possible to split a tail gas stream inside the heat exchange system, for example between the heat exchanger 66 and 67. In particular, the production plant may comprise further heat exchange systems, such that the gaseous NOₓ stream 22 or the NOₓ compressed gas stream 24 exchange heat with the tail gas 5.

As defined herein, a stream of tail gas, or a tail gas stream, is any gas stream downstream the absorption tower 41, between the absorption tower 41 and the point of communication between or the point of mixing of between the first tail gas stream 10 and the oxygen-rich gas 50.

As defined herein, a means for splitting is any means suitable for splitting a tail gas stream, such as to generate a first tail gas stream 10 and a second tail gas stream 80. In particular, the means for splitting is a T-connection having one inlet and two outlets, such that a gas flowing through the inlet of the T-connection is split into two gas streams of identical chemical composition. As defined herein, a pressure release means is any suitable means for reducing the pressure of a gas stream, such as a tail gas stream. In particular, the pressure release means may be a gas expander or a gas ejector. A gas ejector provides the benefits of a simplified equipment, wherein mixing of different gas streams is combined with the reduction of the tail gas pressure. For instance, a tail gas stream, processed via the gas ejector, may act as the motive gas, and a second gas fed to the ejector can, for example, be ambient air at a pressure (e.g. atmospheric pressure) lower than the tail gas stream as motive gas. In particular, a tail gas stream may be fed as the motive gas to a gas ejector, and a second gas fed to the ejector is oxygen gas at a pressure lower than the tail gas stream as motive gas. In this context, both the feeding of air or oxygen through the gas ejector contribute to increasing the concentration in the first tail gas stream 10 and/or a further tail gas stream 83, 84 being recycled, thereby reducing the demand on the oxygen-rich gas 50. In particular, a tail gas stream is fed as the motive gas to the ejector and the second gas fed to the ejector is the NOx gas/steam mixture 15 or the gaseous NOₓ stream 22.

The person skilled in the art will realize that the means for splitting can be incorporated within the (first) pressure release means, provided that the (first) pressure release means includes at least two outlets for the gas stream being depressurized, in particular one outlet for the first tail gas stream 10 and another outlet for the second tail gas stream 80.

As defined herein, a means for adjusting the amount of tail gas being split into the first tail gas stream 10 and the second tail gas stream 80, are any means for controlling the splitting in the means for splitting 55. In particular, the means for splitting 55 is a T-connection as described above and the means for adjusting may be an orifice or a guide vane or a flow control valve at one or both of the outlets of the T-connection. Even more in particular, the means may be an integrated process control system, in which the temperature in the ammonia converter 37 is determined through a means for measuring the temperature. The temperature in the ammonia converter 37 is then used for controlling a flow control means in the means for splitting 55, thereby controlling the splitting the tail gas stream, in order for the measured temperature to be maintained in the range 800-950° C.

As defined herein, a means for adjusting the oxygen concentration is any suitable means for regulating the amount of oxygen to be introduced in the system from a measurement of the oxygen concentration, such as by using a means for measuring the concentration of oxygen. The oxygen concentration can be determined, for example, from a measurement in the gas phase using a process gas analyzer. The oxygen concentration can also be determined from computing using the concentration of the oxygen source being introduced in the system, in particular the oxygen concentration of the oxygen rich gas, the flow at which the oxygen source, in particular the oxygen rich gas, is introduced in the system, particularly the flow at which the ammonia gas stream is introduced in the system and the relative flow values of the gases with which the oxygen source is mixed; in particular the relative flow values at which the oxygen rich gas and the ammonia gas stream are mixed. Using the oxygen concentration, the relevant flow of oxygen to be introduced in the system is, in turn, determined and is used in controlling the flow of oxygen, from a gaseous source of oxygen at a pre-determined concentration. Controlling of the flow of gaseous oxygen can, for example, be achieved through flow control valves. In this context, as defined herein, a means for regulating the concentration of ammonia and/or oxygen is any means suitable for achieving a target concentration of ammonia and/or oxygen. In particular, such means are gas flow control means, in particular a flow control valve or an orifice or a guiding vane, for controlling the flow of the oxygen rich gas and/or the ammonia gas stream. In particular, the means is an integrated process control system, in which the concentration of oxygen is measured, and the target flow or relevant flow of oxygen is thereby determined and achieved from controlling the flow of the first oxygen rich gas, from a gaseous source of oxygen at a pre-determined concentration.

The person skilled in the art will determine the optimal concentration of oxygen in the gases entering the ammonia converter 37 and the absorption tower 41, in order for the catalytic conversion of ammonia to nitric oxide to proceed optimally in the ammonia converter 37 and for the absorption of NOₓ gases in the absorption tower 41 to proceed optimally. Further, upon determining the oxygen content exiting the absorption tower 41, he will also weigh out the benefits of increasing the oxygen content in the absorption tower 41, against the drawback of a higher gas volume downstream the absorption tower 41, such implying equipment, such as heat exchangers, of a larger size, for heating tail gas.

As defined herein, means for measuring the temperature are any means suitable for measuring and indicating the temperature in the ammonia oxidation burner. In particular, the means for measuring the temperature is a thermocouple or a thermometer suitable for measuring and indicating a temperature ranging as high as 1,000° C. More in particular, the means for measuring the temperature is an infrared thermometer for measuring and indicating a temperature ranging as high as 1,000° C.

As defined herein, means for converting steam into power are any means for achieving power from steam. In particular those means are a steam turbine connected to an electric generator.

Considering that a production cycle of a unit or plant comprises a start-up phase, wherein the different processes are initiated; a continuous and essentially constant phase or operation mode, wherein processes operate at a given working load that is usually kept constant during a production cycle; and a shutdown phase, where processes are slowly and safely stopped, the term “during operation” or “during continuous operation” of a unit or plant, in particular of a nitric acid plant, refers to the continuous operation mode wherein the unit or plant produces a product, in particular nitric acid.

The inventors have found that, instead of continuously supplying compressed air 34 provided by an air compressor 36 to the mixing unit 35, in particular during continuous operation of the nitric acid plant, it is possible to recirculate the first tail gas stream 10 at a pressure P1. Therefore, pressurized air only has to be supplied in order to start the process, i.e. during the start-up phase of the nitric acid plant, in particular to pressurize the system, but no longer after the production of the tail gas 5 has started and an air compressor 36 is not required. The tail gas 5 has a pressure higher than P1 and, therefore, a first pressure release means, such as the tail gas expander 7, can be used to provide reduce the pressure of the tail gas stream and provide a tail gas stream with pressure P1. In addition, the oxygen-rich gas 50 and the supply of a second oxygen-containing gas 68, which typically have a pressure equal to or higher than P1 and up to P2 to provide oxygen to the ammonia converter 37 and to the absorption tower 41, respectively, such that, in the absence of the primary and secondary air provided by the air compressor 36, the concentration of oxygen in the ammonia converter 37 and in the absorption tower 41 is similar to and can be controlled to that in a standard dual pressure nitric acid plant.

In the absence of an air compressor 36 and with the tail gas stream 10 being recirculated in the system, not only is the power demand of the system reduced, but the NOₓ emissions leaving the system are also reduced. Therefore, the size of the treatment unit for treating those NOₓ emissions is reduced with respect to the size in the corresponding standard dual pressure nitric acid plant.

In one embodiment according to the production plant of the disclosure, the system further comprises one or more of:
a steam turbine 51, wherein the steam turbine can at least partly power the NOₓ gas compressor 40;
a heat exchanger 79 for exchanging heat between the first expanded tail gas 64 and a colder tail gas stream, particularly wherein the first expanded tail gas 64 exits the heat exchanger 79 at a temperature below 300°, and wherein the first expanded tail gas 64 downstream the heat exchanger 79 is in direct fluid communication with the means for splitting 55. Stated differently, the expanded tail gas 64 exchanges heat with the tail gas 5 in the heat exchanger 79 and, particularly exits the heat exchanger 79 at a temperature below 300° C., wherein the expanded tail gas 64 having exchanged heat with the tail gas 5 is the stream of tail gas split by the means for splitting 55 downstream the heat exchanger 79;
a De-NOₓ treatment unit 70, particularly located in a tail gas stream downstream the absorption tower 41; and
a second pressure release means 60 for expanding the second tail gas stream 80 to atmospheric pressure, to produce a second expanded tail gas 69. Said pressure release means 60 may be any means suitable for reducing the pressure of the second tail gas stream 80, in particular by expanding the second tail gas stream 80. Such means are for example, a pressure release valve or a gas expander.

Advantageously, the means for splitting 55 are located downstream the heat exchange system 43. Indeed, both the first tail gas stream 10 and the second tail gas stream 80 are then at an optimal temperature. In particular, this means that the first stream of tail gas 10 is at a temperature below 300° C., such that the first tail gas stream 10 can be fed to the ammonia converter 37 without the amount of ammonia fed through the stream 32, having to be adjusted in order to maintain the temperature ranging from 800 to 950° C. in the ammonia converter 37, the temperature at which the ammonia converter 37 is operable. In addition, the location of the means for splitting 55 at this location confers to the second tail gas stream 80 an optimal temperature for being expanded in the pressure release means 60, in particular a tail gas expander, such as to provide an optimal of energy which can be used to power the NOₓ gas compressor 40. Further, the presence of a steam turbine 51 allows for the recovery of the heat of the steam produced in the ammonia converter 37 and this recovered heat can be used, at least partly, for powering the tail NOₓ gas compressor 40. Finally, the use of the steam turbine 51 contributes to operating the production plant in an energy-efficient manner.

In particular, the tail gas 5 is heated in a heat exchanger 67 of the heat exchange system 43 and then in the heat exchanger 79 from a temperature ranging from 20 to 250° C., to a temperature ranging from 100 to 450° C. Subsequently, the tail gas exiting the heat exchanger 79 is heated in the heat exchange system 43 to a temperature ranging from 200 to 550° C. The tail gas exiting the heat exchanger 79 then is at an optimal temperature for being treated in the De-NOₓ treatment unit 70 and, therefore, the De-NOₓ treatment unit 70 is located between the heat exchanger 79 and the heat exchange system 43. The person skilled in the art will, without any difficulty, select the proper location for the De-NOₓ treatment unit 70 such that the operating temperature of the De-NOₓ treatment unit 70 is in agreement with the temperature of the corresponding stream of tail gas.

In one embodiment according to the production plant of the disclosure, the system further comprises a bleacher 62 for bleaching the stream of raw nitric acid-containing residual NOₓ gas 27, to provide a stream of bleached nitric acid 75, wherein the bleacher has an inlet 81 for an oxygen-rich bleaching gas 72, in particular wherein the inlet 81 is in fluid communication with a high-pressure water electrolyzer 63, and an outlet 73 for the bleacher's off-gases 77. It is understood that the bleacher 62 further comprises an inlet for the stream of raw nitric acid containing residual NOₓ gas and an outlet for bleached nitric acid. The bleaching gases or off-gases 77 are in fluid communication with any gas stream downstream the ammonia converter 37 and upstream the NOₓ gas compressor 40 if the bleacher 62 operates at a pressure higher than P1 and up to equal to P2 (FIG. 2B), or in fluid communication with any stream downstream the NOₓ gas compressor 40 if the bleacher 62 operates at a pressure equal to or higher than P2 (FIG. 2D), such that the supply for or source of the second oxygen-containing gas 68, 72, 77 comes at least partly from the off-gases 77.

When the stream of raw nitric acid containing residual NOₓ gas 27 is bleached, the amounts of NOₓ gases and nitrous acid HNO₂ in the nitric acid solution are reduced. This in turn results in less brown fumes coming out of the nitric acid solution. In addition, the nitric acid solution provided by the bleacher is of a higher quality, that is purer.

Conveniently, when the stream of raw nitric acid containing residual NOₓ gas 27 is bleached, the bleaching gases or off-gases 77 correspond to the second oxygen containing gas (or the oxygen-rich gas supplied by the supply 68) having a pressure higher than P1 and up to P2 (FIG. 2B) or having a pressure higher than P2 (FIG. 2D): the supply of the oxygen-rich gas having pressure higher than P1 and up to P2 (FIG. 2B) or higher than P2 (FIG. 2D), in particular the second oxygen-containing gas, is achieved through the bleacher 62, as the bleacher off-gases 77, and no separate source of oxygen is required.

In one embodiment according to the production plant of the disclosure, part of the oxygen-rich gas 50 or part of the first oxygen-containing gas 56 or part of the tail gas 5, such as part of a tail gas stream 83, 84, is in fluid communication with the inlet 81 of the bleacher 62, such that the oxygen rich-bleaching gas or stripping gas 72 is at least partly provided by part of the oxygen-rich gas 50 or part of the oxygen-containing gas 56 or part of the tail gas 5, such as part of a tail gas stream 83, 84.

If a bleacher 62 is present, as no secondary air is fed by an air compressor (36 in the standard nitric acid plant) to the bleacher 62, the bleacher 62 can be conveniently fed by the oxygen-rich gas 50. Also, once tail gas 5 is produced and recirculated, the first oxygen-containing gas 56 or part of a tail gas stream can be fed to the bleacher 62: the concentration of NOₓ gases in the oxygen-containing gas 56 or the tail gas 5 is sufficiently low that the bleaching in the bleacher 62 remains sufficiently efficient.

In particular, the system further comprises means for pressurizing 78 the oxygen-rich gas 50 or the first oxygen-containing gas 56 or the tail gas 5, when used as a stripping gas in the bleacher, to a pressure equal to or higher than P2, such that the bleacher 62 is a high-pressure bleacher, that is a bleacher operating at a pressure ranging from above 6 bara and up to 16 bara (FIG. 2D). Those means for pressurizing 78 can, for example, be a gas compressor.

In one embodiment according to the production plant of the disclosure, the system further comprises a stream of a second oxygen-rich gas 74 in direct fluid communication with any tail gas stream downstream the absorption tower 41. More in particular, the system further comprises a stream of a pressurized oxygen-rich gas in direct fluid communication with any tail gas stream upstream the first pressure release means 7.

The feeding of a stream of a second oxygen-rich gas 74 allows to reduce the amount of the first oxygen-rich gas 50 having to be provided to the mixing unit 35. In particular, the stream of the second oxygen-rich gas 74 can be fed downstream the heat exchange 43 and upstream the first pressure release means 7, which allows more power to be exported from the first pressure release means, e.g. from the tail gas expander 7.

In one embodiment according to the production plant of the disclosure, the first oxygen-rich gas 50, the second oxygen containing gas 68, 72, 77, the stream of the second oxygen-rich gas 74, which is particularly in fluid communication with any stream of tail gas downstream the absorption tower 41, and the oxygen-rich bleaching gas 72 and the off-gases 77 are all provided at least partly by a water electrolyzer 63, in particular a high-pressure water electrolyzer 63.

A water electrolyzer is a device for the electrolysis of water, being the decomposition of water into oxygen and hydrogen gas, due to the passage of an electric current therethrough. This technique can be used to make hydrogen gas, a main component of hydrogen fuel, and oxygen gas. A suitable high-pressure water electrolyzer may comprise an anode producing oxygen gas according to the reaction

2OH—=H₂O+½O₂+2e−;
a cathode, producing hydrogen gas according to the reaction

2H₂O+2e−=H₂+2OH−;
an electrolyte consisting of an alkaline solution such as potassium hydroxide; and a porous diaphragm separating the anode and the cathode, in order to avoid the mixing of hydrogen gas and oxygen gas that together form an explosive mixture. Alternatively, the anode and the cathode may be separated by a solid polymer electrolyte such as the fluoropolymer Nafion, where the electrolyte provides the selective transport of protons from the anode to the cathode, as well as the electrical insulation between the anode and the cathode, and avoids the mixing of hydrogen gas and oxygen gas that together form an explosive mixture.

The anode and cathode can be made of nickel or steel, or mixtures thereof. Alternatively, for the purpose of enhancing the electrode reactions, the anode and cathode may contain catalysts that can be made of Iridium and Platinum, respectively. The diaphragm of an electrically insulating material is based on, for example, zirconia. The diaphragm has a porosity such that it forms a barrier against transport of hydrogen and oxygen gas bubbles, while containing a continuum of penetrated liquid electrolyte. An anode-diaphragm-cathode assembly constitutes an electrolysis cell. Electrolysis cells are piled in series in stacks that compose the core of an electrolyzer. The hydrogen and oxygen production for a given stack volume is proportional to the current density and inversely proportional to the stacking distance. Regardless of stack volume, the hydrogen and oxygen production is proportional to the total current. In addition to the stack, the electrolyzer comprises auxiliaries such as a current rectifier, a water demineralization unit, a water pump and a cooling system, a hydrogen purification unit, and instrumentation.

The electrolyzer is operated by applying a voltage corresponding to the standard potential plus the overpotential over each cell. The total voltage depends on the total number of cells of which the electrolyzer is comprised. OH— ions generated at the cathode migrate through the electrolyte in the diaphragm to the anode, where they are consumed by the anode reaction. Electrons travel the opposite direction in an external circuit. The electrolyzer may be operated at a temperature of 50 to 80° C., or 60 to 80° C., and a gas pressure of 2 bara, preferably 9 to 30 bara—as a high pressure water electrolyzer, even more preferably 15 to 30 bara.

A high-pressure water electrolyzer hence results in the production of pressurized hydrogen at the cathode and pressurized oxygen at the anode, such as having a pressure of 9 to 30 bara, even more preferably a pressure of 15 to 30 bara. What is required to perform high-pressure electrolysis is to pressurize the water used in the electrolysis process. As pressurizing water requires less power than pressuring a gas, the use of a high-pressure water electrolyzer results in the production of pressurised oxygen-rich gas at minimized power consumption.

Conveniently, the water electrolyzer 63 provides oxygen to all the various points where oxygen needs to be fed. In particular, the supply of oxygen from the electrolyzer 63, is sufficient to provide all of the oxygen of the first oxygen-rich gas, the second oxygen-rich gas 74, the second oxygen-containing gas 68, the oxygen-rich bleaching gas 72, and the off-gases 77. In this manner, the system is simplified and comprises a single source of oxygen from which different oxygen-containing gas streams can be produced. In particular, oxygen-containing gas streams can be produced at the desired pressure, using standard pressure adjustment means. The use of a high-pressure electrolyzer operable at 9 to 30 bara is particularly useful as a source of oxygen gas to be supplied to a bleacher operating at a pressure higher than P2.

Another advantage of the presence of a high-pressure water electrolyzer lies in the potential to, in parallel to producing oxygen gas that can be used in the nitric acid production, also produce hydrogen gas. Such hydrogen gas is produced in a green manner, i.e. without the conventional use of natural gas, which results in the production of the greenhouse gas carbon dioxide. The hydrogen gas can then be used in the production of ammonia in a Haber-Bosch process, also conventionally named synthesis gas unit. The high pressure water electrolyzer thus enables the integration of the ammonia and nitric acid production processes.

In one embodiment according to the production plant of the disclosure, the fluid communication between the source of pressurized air 65, for pressurizing the system during the startup phase, and the system is in direct fluid communication with the first oxygen-rich gas 50, particularly having a pressure P1.

It is preferred to introduce pressurized air 65 at the start-up in the tail gas stream in direct fluid communication with the oxygen-rich gas 50. In this manner, upon operating the NOₓ compressor 40 during the start-up of the system, it is ensured that air flows through the converter 37 when ammonia 32 is being fed to converter 37, such that there is a sufficient concentration of oxygen to convert ammonia into nitric oxide. Subsequently, the nitric acid process being induced, the tail gas 5 is produced and the first tail gas stream 10 can be recirculated to the mixing unit 35, upon feeding the oxygen-rich gas 50.

### Method for Producing Nitric Acid

Reference is made to FIGS. 2A, 2B, 2C and 2D. In one aspect of the disclosure, a method for producing nitric acid at reduced power consumption and reduced emissions, in a production plant according to the production plant of the disclosure, is disclosed. The method comprises the steps of
a) preferably, pressurizing the system by supplying the pressurized air 65 in the system;
b) preferably, operating the NOₓ gas compressor 40 or the first pressure release means (e.g. tail gas expander) 7 using external power, thereby inducing a pressurized airflow in the system and further pressurizing the system to a pressure P2 downstream the NOₓ gas compressor 40;
c) supplying the ammonia gas stream 32 and a first oxygen containing gas to the mixing apparatus 35, thereby producing the ammonia/oxygen-containing gas mixture 14;
d) oxidising ammonia in the ammonia/oxygen-containing gas mixture 14 in the ammonia converter 37, at a pressure equal to or higher than P1 and lower than P2, in particular at a pressure P1, particularly at a temperature ranging from 800 to 950° C., thereby producing the gaseous NOₓ gas/steam mixture 15, comprising water and nitric oxide;
e) cooling the NOₓ gas in the gaseous NOₓ gas/steam mixture 15 in the heat exchange system 43 and in the first gas/cooler condenser 38, thereby producing an aqueous diluted nitric acid mixture 17 and a gaseous NOₓ stream 22;
f) compressing the gaseous NOₓ stream 22 in the NOₓ gas compressor 40, thereby providing the pressurized NOₓ compressed gas stream 24 having a pressure P2;
g) absorbing the compressed gaseous NOₓ stream 24 in the absorption tower 41, thereby providing the stream of raw nitric acid-containing residual NOₓ gas 27 and the tail gas 5 comprising NOₓ gases;
h) heating the tail gas 5 in the heat exchange system 43, with the heat from the NOₓ gas/steam mixture 15 coming from the ammonia converter 37, particularly to a temperature ranging from 150 to 650° C.;
i) cooling the compressed NOₓ gas stream 24 in a second gas cooler/condenser 39, thereby providing a compressed NOₓ gas stream 24, particularly having a temperature ranging from 20 to 60° C.; and
j) expanding at least part the tail gas 5 obtained in step h) in a first pressure release means (e.g. a tail gas expander 7), thereby providing the first expanded tail gas 64.

The method is characterized in that it further comprises the steps of
k) in particular, splitting a tail gas stream with a first means for splitting 55 into a first tail gas stream 10 and a second tail gas stream 80, and mixing the first tail gas stream 10 with the (first) oxygen-rich gas 50, thereby providing the first oxygen-containing gas 56;
l) optionally, measuring the oxygen concentration in the first oxygen-containing gas 56;
m) adjusting the flow of the first oxygen-rich gas 50 (e.g. having a pressure P2) being mixed in step k), or the flow of the ammonia gas, such that the oxygen to ammonia molar ratio at the inlet of the ammonia converter 37 is at least 1.2 or 1.25, such as between 1.2 and 9, between 1.25 and 9 or between 1.3 and 9; or stated differently, such as to maintain the oxygen to ammonia molar ratio inside the ammonia converter 37 at a ratio of at least 1.2 or 1.25, such as ranging from 1.2 to 9, from 1.25 to 9 or from 1.3 to 9, particularly if the oxygen concentration measured in step l) is such that the oxygen to ammonia molar ratio in the ammonia converter 37 is less than 1.2 or 1.25;
n) optionally, measuring the temperature in the ammonia converter 37;
o) optionally, adjusting the gas volume being mixed in step k) or the ammonia gas stream 32 supplied in step d), if the temperature measured in step n) is outside the range of 800-950° C., such that the temperature in the ammonia converter is maintained in the range of 800-950° C.;
p) optionally, measuring the oxygen concentration in the tail gas 5 downstream the absorption tower 41;
q) adjusting the flow or supply of the second oxygen-containing gas 68, 72, 77, particularly at a pressure equal to or higher than P1 and up to P2 upstream the NOₓ gas compressor 40, or at a pressure higher than P2 downstream the NOₓ gas compressor 40, such that the oxygen concentration in a tail gas stream 5, 10, 64, 69, 80, 83, 84 contains at least 0.5% by volume oxygen, particularly if the oxygen concentration measured in step p) is less 0.5% by volume oxygen.
r) in particular, repeating steps c) to q).

Typically, P1 ranges from 2 to 6 bara and P2 ranges from 9 to 16 bara. The person skilled in the art will determine the optimal concentration of oxygen in the gases entering the ammonia converter 37 and the absorption tower 41, in order for the catalytic conversion of ammonia to nitric oxide to proceed optimally in the ammonia converter 37 and for the absorption of NOₓ gases in the absorption tower 41 to proceed optimally. Further, upon determining the oxygen content exiting the absorption tower 41, he will also weigh out the benefits of increasing the oxygen content in the absorption tower 41, such as a reduced tower size due to improved absorption, against the drawback of a higher gas volume downstream the absorption tower 41, which requires equipment, such as heat exchangers, of a larger size, for heating tail gas.

In particular, the gaseous NOₓ stream 22 or the NOₓ compressed gas stream 24 exchange heat with the tail gas 5. In particular, the gaseous NOₓ stream 22 or the NOₓ compressed gas stream 24 exchange heat with the tail gas 5.

The inventors have found that, instead of continuously supplying compressed air 34 provided by an air compressor 36 to the mixing unit 35, it is possible to recirculate the first tail gas stream 10 at a pressure P1, in particular during continuous operation of the nitric acid plant. Therefore, compressed or pressurized air only has to be supplied in order to start the process, i.e. during the start-up phase of the nitric acid plant, for pressurizing the system, but no longer after the production of the tail gas 5 has started, during the continuous operation phase or mode of the nitric acid plant, and an air compressor 36 is not required. The tail gas 5 has a pressure higher than P1 and, therefore, a first pressure release means 7, such as a tail gas expander, can be used to provide a stream of tail gas of pressure P1. In addition, the first oxygen-rich gas 50 and the second oxygen-containing gas 68, having either a pressure equal to or higher than P1 and up to P2, provide oxygen to the ammonia converter 37 and to the absorption tower 41, respectively, such that, in the absence of the primary and secondary air provided by the air compressor 36, the concentration of oxygen in the ammonia converter 37 and in the absorption tower 41 is similar to that in a standard dual pressure nitric acid plant.

In the absence of an air compressor 36 and with the first tail gas stream 10 being recirculated in the system, not only is the power demand of the system reduced: the NOₓ emissions leaving the system are also reduced. Therefore, the size of the treatment unit for treating those NOₓ emissions is reduced with respect to the size in the corresponding standard dual pressure nitric acid plant.

In one embodiment according to the method of the disclosure, the first tail gas stream 10 mixed in step k) is obtained after step j), in particular the first expanded tail gas 64 is split in step k), and the method further comprises the steps of
s) particularly before step k), heating up, in the heat exchanger 79, a tail gas stream which is colder than the first expanded tail gas 64 with the first expanded tail gas 64, thereby bringing the expanded tail gas to be mixed in step k to a temperature below 300°; in particular before step k), heating up, in the heat exchanger, the tail gas 5 obtained in step g) with the first expanded tail gas obtained in step j), thereby bringing the tail gas to be mixed in step k) to a temperature below 300° C.;
t) treating a tail gas stream, particularly the tail gas stream obtained from/heated in step s) in the De-NOₓ treatment unit 70;
u) expanding the second tail gas stream 80 in the second pressure release means 60, thereby providing the second expanded tail gas 69. The second pressure release means 60 may be any means suitable for reducing the pressure of a gas stream, hence expanding a gas stream, in particular the second tail gas stream 80. Such means are for example, a pressure release valve or a gas expander; and
v) recovering at least part of the steam generated in the ammonia converter 37 in the steam turbine 51.

Advantageously, the means for splitting 55 are located downstream the heat exchange system 43. Indeed, both the first tail gas stream 10 and the second tail gas stream 80 are then at an optimal temperature. This means that the first stream of tail gas 10 is at a temperature below 300° C., such that the first tail gas stream 10 can be fed to the ammonia converter 37 without the amount of ammonia fed through the stream 32, having to be adjusted in order to maintain the temperature in the ammonia converter, ranging from 800 to 950° C., the temperature at which the ammonia converter 37 is operable. In addition, the location of the means for splitting 55 at this location confers to the second tail gas stream 80 an optimal temperature for being expanded in the pressure release means 60 such as to provide an optimal of energy which can be used to power the NOₓ gas compressor 40. Further, the presence of a steam turbine 51 allows for the recovery of the heat of the steam produced in the ammonia converter 37 and this recovered heat can be used, at least partly, for powering the tail NOₓ gas compressor 40. Finally, the use of the steam turbine 51 contributes to operating the production plant in an energy-efficient manner.

In particular, the tail gas 5 is heated in the heat exchanger 79, in particular in a heat exchanger 67 of the heat exchange system 43 and then in the heat exchanger 79, from a temperature ranging from 20 to 250° C., to a temperature ranging from 100 to 450° C. Subsequently, the tail gas exiting the heat exchanger 79 is heated in the heat exchange system 43, particularly in a heat exchanger 66 of the heat exchange system 43, to a temperature ranging from 200 to 550° C. The tail gas exiting the heat exchanger 79 then is at an optimal temperature for being treated in the De-NOₓ treatment unit 70 and, therefore, the De-NOₓ treatment unit 70 is located between the heat exchanger 79 and the heat exchange system 43. The person skilled in the art will, without any difficulty, select the proper location for the De-NOₓ treatment unit 70 such that the operating temperature of the De-NOₓ treatment unit 70 is in agreement with the temperature of the corresponding stream of tail gas.

In one embodiment according to the method of the disclosure, the method further comprises the step of w) bleaching the stream of raw nitric acid-containing residual NOₓ gas 27 in the bleacher 62, thereby producing the stream of bleached nitric acid 75.

When the stream of raw nitric acid containing residual NOₓ gas is bleached, the amounts of NOₓ gases and nitrous acid HNO₂ in the nitric acid solution are reduced. This in turn results in less brown fumes coming out of the nitric acid solution. In addition, the nitric acid solution provided by the bleacher is of a higher quality, that is purer.

Conveniently, when the stream of raw nitric acid containing residual NOₓ gas 27 is bleached, the bleaching gases or off-gases 77 correspond to the second oxygen-containing gas supplied by the corresponding supply or source 68 for an oxygen-rich gas having a pressure higher than P1 and up to P2 (FIG. 2B) or higher than P2 (FIG. 2D): the supply of the second oxygen-containing gas having pressure higher than P1 and up to P2 (FIG. 2B) or higher than P2 (FIG. 2D) is the bleacher 62, in particular the bleacher off-gases 77, and no separate source of oxygen is required.

In one embodiment according to the method of the disclosure, the method further comprises the step of w1) supplying part of the first oxygen-rich 50 or part of the first oxygen-containing gas 56 obtained in step k) or part of the tail gas stream 5, 83, 84, such as obtained in step g), to the bleacher 62 in step w).

If a bleacher 62 is present, i.e. if such a bleaching step is performed, as no secondary air is fed by an air compressor (36 in the standard nitric acid plant) to the bleacher 62, the bleacher 62 can be conveniently fed by the first oxygen-rich gas 50. Also, once tail gas 5 is produced and recirculated, the first oxygen-containing gas 56 or part of the tail gas stream can be fed to the bleacher 62: the concentration of NOₓ gases in the first oxygen-containing gas 56 or the tail gas 5 is sufficiently low that the bleaching in the bleacher 62 remains sufficiently efficient.

In particular, the system further comprises the step of w2) pressurizing the first oxygen-rich gas 50, part of a tail gas stream, and/or the first oxygen-containing gas 56 to be supplied to the bleacher in the means for pressurizing 78, to a pressure higher than P2, such that the bleacher 62 is a high-pressure bleacher, that is a bleacher operating at a pressure ranging from above 6 or 9 bara and up to 16 bara (FIG. 2D). Those means for pressurizing 78 can, for example, be a gas compressor.

In one embodiment according to the method of the disclosure, the method further comprises the step of x) supplying a stream of a second oxygen-rich or oxygen-containing gas 68, 72, 77, particularly as a stream of a pressurized oxygen-rich gas, to a tail gas stream, particularly to a tail gas stream upstream the first pressure release means 7. The feeding of a stream of a second oxygen-rich gas 74 allows to reduce the amount of the first oxygen-rich gas 50 having to be provided to the mixing unit 35. In particular, the stream of a second oxygen-rich gas 74 can be fed downstream the heat exchanger 43 and upstream the first pressure release means 7, such as a tail gas expander, which allows more power to be exported from the first pressure release means 7, such as a tail gas expander.

In one embodiment according to the method of the disclosure, the method further comprises the steps of
y) operating the water electrolyzer 63, thereby producing oxygen-gas, particularly operating a high-pressure water electrolyzer, thereby producing pressurized oxygen gas; and
z) providing, from the oxygen produced by the water electrolyzer 63 in step y), at least part of the (first) oxygen-rich gas 50, the second oxygen containing gas 68, 72, 77, the second oxygen-rich gas 74 (particularly in fluid communication with any stream of tail gas downstream the absorption tower 41), and the oxygen-rich bleaching gas 72 and the off-gases 77.

Conveniently, the water electrolyzer 63 provides oxygen to all the various points where oxygen needs to be fed. In particular, the supply of oxygen from the electrolyzer 63 is sufficient to provide all of the oxygen of the first oxygen-rich gas 50, the second oxygen-rich gas 74, the second oxygen containing gas 68, the oxygen-rich bleaching gas 72 and the off-gases 77. In this manner, the system is simplified and can comprise a single source of oxygen from which different oxygen-containing gas streams can be produced. In particular, different oxygen containing streams can be produced at the desired pressures, using standard pressure adjustment means. The use of a high-pressure electrolyzer operable at a pressure of 9 to 30 bara, preferably at a pressure of 15 to 30 bara, is particularly useful as a source of oxygen gas that can be supplied to a bleacher operating at a pressure higher than P2.

Another advantage of the presence of a high-pressure water electrolyzer lies in the potential to, in parallel to producing oxygen gas that can be used in nitric acid production, also produce hydrogen gas. Such hydrogen gas is produced in a green manner, i.e. without the conventional use of natural gas, which results in the production of the greenhouse gas carbon dioxide. The hydrogen gas can then be used in the production of ammonia in a Haber-Bosch process, also conventionally named synthesis gas unit. The high pressure water electrolyzer thus enables the integration of the ammonia and nitric acid production processes. Furthermore, as pressurizing water requires less energy than pressurizing a gas, the use of a high-pressure water electrolyzer results in the production of pressurized oxygen-rich gas at minimized power consumption.

In one embodiment according to the method of the disclosure, in step a), the pressurized air 65, particularly having a pressure P1, is supplied in the stream in direct fluid communication with the oxygen-rich gas 50, particularly having a pressure P2.

It is preferred to introduce pressurized air 65 at the start-up in the tail gas stream in direct fluid communication with the oxygen-rich gas 50. In this manner, upon operating the means for pressurizing and the NOₓ compressor during the start-up of the system, it is ensured that air flows through the converter 37 when ammonia 32 is being fed to converter 37, such that there is a sufficient concentration of oxygen to convert ammonia into nitric oxide. Subsequently, the nitric acid process being induced, the tail gas 5 is produced and the first tail gas stream 10 and recirculated to the mixing unit 35, and mixed with the first oxygen-rich gas 50.

### Use of the Production Plant of the Disclosure

In one aspect of the disclosure, the use of the production plant of the disclosure for performing the method of the disclosure, is disclosed.

### Method for Revamping a Nitric Acid Production Plant

In one aspect of the disclosure, a method for revamping a production plant for producing nitric acid, in particular for revamping an existing production plant into a production plant according to the present disclosure is disclosed, wherein the existing system or production plant for producing nitric acid comprises:
an air compressor 36 for providing a compressed air stream 34;
a mixing apparatus 35, for mixing the compressed air stream 34 with an ammonia gas stream 32, to produce an ammonia/oxygen-containing gas mixture 14;
preferably, means for adjusting the supply of the ammonia gas stream 32 to the mixing apparatus 35;
an ammonia converter 37, particularly operable at a pressure equal to or higher than P1 but lower than P2, particularly operable at a pressure P1, for oxidising ammonia in the ammonia/oxygen-containing gas mixture 14, to produce a NOₓ gas/steam mixture 15, comprising water and nitric oxide;
preferably, means for measuring the temperature in the ammonia converter 37;
a first gas cooler/condenser 38, downstream the ammonia converter 37, to produce an aqueous diluted nitric acid mixture 17 and a gaseous NOₓ stream 22;
a NOₓ gas compressor 40 for compressing the gaseous NOₓ stream 22, to produce a compressed or pressurized NOₓ gas stream 24 at a pressure P2;
an absorption tower 41 for absorbing the NOₓ gases from the compressed NOₓ gas stream 24 in water, to produce a stream of raw nitric acid-containing residual NOₓ gas 27 and a tail gas 5 comprising NOₓ gases, comprising an absorption tower tail gas outlet 6 for evacuating the tail gas 5;
preferably, means for measuring the concentration of oxygen in the tail gas 5 in a tail gas stream downstream the absorption tower 41;
a heat exchange system 43 for exchanging heat between the NOₓ gas/steam mixture 15 and the tail gas 5; particularly for heating a tail gas stream with the heat from the NOx gas/steam mixture from the ammonia converter;
a second gas cooler/condenser 39 for separating and condensing steam from the compressed NOₓ gas stream 24 located between the NOₓ compressor and the absorption tower, particularly to produce a compressed NOₓ gas stream 24 having a temperature ranging from 20 to 60° C.; and
a first pressure release means or tail gas expander 7 located downstream the heat exchange system 43, for expanding a stream of tail gas downstream the absorption tower 41, to produce a first expanded tail gas 64, wherein the first pressure release means or tail gas expander 7 can at least partly power the NOₓ gas compressor 40.

The revamping method comprises the steps of
preferably, introducing a source of pressurized air 65 in fluid communication with the production plant, suitable for pressurizing the production plant during startup, in particular wherein the source of pressurized air is capable of providing from 2,000 to 19,000 m³/h of pressurized air;
introducing a supply or source of an oxygen-rich gas 50, such as a high-pressure water electrolyzer, providing part of a first oxygen containing gas, upstream of and in fluid communication with the mixing apparatus 35;
preferably, introducing means for measuring the oxygen concentration in the oxygen-containing gas 56;
preferably, introducing means for adjusting the concentration of oxygen in the oxygen-containing gas 56 such that the oxygen to ammonia molar ratio at the inlet of the ammonia converter 37 is at least 1.2 or 1.25, particularly between 1.2 and 9 or between 1.25 and 9. More in particular, there may be introduced a means for regulating the concentration of ammonia and/or oxygen in the ammonia converter, particularly a means for controlling the flow of the oxygen-rich gas or the flow of the first oxygen-containing gas and/or a means for controlling the flow of the ammonia gas stream, for maintaining the oxygen to ammonia molar ratio inside the ammonia converter at a ratio of at least 1.2 or 1.25, particularly between 1.2 and 9, between 1.25 and 9 or between 1.3 and 9;
in particular, introducing a supply of a second oxygen-containing gas 68, 72, 77, having either (i) a pressure equal to or higher than P1 and up to P2 for supplying oxygen upstream the NOₓ gas compressor, or (ii) a pressure higher than P2, for supplying oxygen to the compressed NOₓ gas stream, such that a tail gas stream 5, 10, 62, 69, 80, 83, 84 contains at least 0.5% by volume of oxygen;
introducing a means for splitting 55 a stream of tail gas downstream the absorption tower 41 into a first tail gas stream 10 and a second tail gas stream 80, wherein the first tail gas stream is in fluid communication with the first oxygen-rich gas 50, wherein the mixing of the first tail gas stream and the first oxygen rich gas provides the first oxygen-containing gas;
particularly introducing a means for adjusting the amount of tail gas being split into the first tail gas stream 10 and the second tail gas stream 80; and
removing the air compressor 36.

The term “oxygen-rich gas” is used as defined elsewhere herein.

Typically, the heat exchange system 43 comprises at least two heat exchangers 66, 67. The person skilled in the art will realize that it is possible to split a stream of tail gas inside the heat exchange system, for example between the heat exchanger 66 and 67. In particular, the production plant both prior to and after revamping comprises further heat exchange systems, such that the gaseous NOₓ stream 22 or the NOₓ compressed gas stream 24 exchange heat with the tail gas 5.

As defined herein, a stream of tail gas/a tail gas stream is any gas stream downstream the absorption tower, such as located between the absorption tower 41 and the point of communication between or mixing of the first tail gas stream 10 and the (first) oxygen-rich gas 50.

As defined herein, a means for splitting is any means suitable for splitting a tail gas stream, such as to generate a first tail gas stream 10 and a second tail gas stream 80. In particular, the means for splitting is a T-connection having one inlet and two outlets, such that a gas flowing through the inlet of the T-connection is split into two gas streams of identical chemical composition. As defined herein, a pressure release means is any suitable means for reducing the pressure of a gas stream, such as a tail gas stream. In particular, the pressure release means may be a gas expander or a gas ejector. A gas ejector provides the benefits of a simplified equipment, wherein mixing of different gas streams is combined with the reduction of the tail gas pressure. For instance, a tail gas stream, processed via the gas ejector, may act as the motive gas, and a second gas fed to the ejector can, for example, be ambient air at a pressure (e.g. atmospheric pressure) lower than the tail gas stream as motive gas. In particular, a tail gas stream may be fed as the motive gas to a gas ejector, and a second gas fed to the ejector is oxygen gas at a pressure lower than the tail gas stream as motive gas. In this context, both the feeding of air or oxygen through the gas ejector contribute to increasing the concentration in the first tail gas stream 10 and/or a further tail gas stream 83, 84 being recycled, thereby reducing the demand on the oxygen-rich gas 50. In particular, a tail gas stream is fed as the motive gas to the ejector and the second gas fed to the ejector is the NOx gas/steam mixture 15 or the gaseous NOₓ stream 22.

The person skilled in the art will realize that the means for splitting can be incorporated within the (first) pressure release means, provided that the (first) pressure release means includes at least two outlets for the gas stream being depressurized, in particular one outlet for the first tail gas stream 10 and another outlet for the second tail gas stream 80.

As defined herein, a means for adjusting the amount of tail gas being split into the first tail gas stream 10 and the second tail gas stream 80, are any means for controlling the splitting in the means for splitting 55. In particular, the means for splitting 55 is a T-connection as described above and the means for adjusting may be an orifice or a guide vane or a flow control valve at one or both of the outlets of the T-connection. Even more in particular, the means may be an integrated process control system, in which the temperature in the ammonia converter 37 is determined through a means for measuring the temperature. The temperature in the ammonia converter 37 is then used for controlling a flow control means in the means for splitting 55, thereby controlling the splitting the tail gas stream, in order for the measured temperature to be maintained in the range 800-950° C.

As defined herein, a means for adjusting the oxygen concentration is any suitable means for regulating the amount of oxygen to be introduced in the system from a measurement of the oxygen concentration, such as by using a means for measuring the concentration of oxygen. The oxygen concentration can be determined, for example, from a measurement in the gas phase using a process gas analyzer. The oxygen concentration can also be determined from computing using the concentration of the oxygen source being introduced in the system, in particular the oxygen concentration of the oxygen rich gas, the flow at which the oxygen source, in particular the oxygen rich gas, is introduced in the system, particularly the flow at which the ammonia gas stream is introduced in the system and the relative flow values of the gases with which the oxygen source is mixed; in particular the relative flow values at which the oxygen rich gas and the ammonia gas stream are mixed. Using the oxygen concentration, the relevant flow of oxygen to be introduced in the system is, in turn, determined and is used in controlling the flow of oxygen, from a gaseous source of oxygen at a pre-determined concentration. Controlling of the flow of gaseous oxygen can, for example, be achieved through flow control valves. In this context, as defined herein, a means for regulating the concentration of ammonia and/or oxygen is any means suitable for achieving a target concentration of ammonia and/or oxygen. In particular, such means are gas flow control means, in particular a flow control valve or an orifice or a guiding vane, for controlling the flow of the oxygen rich gas and/or the ammonia gas stream. In particular, the means is an integrated process control system, in which the concentration of oxygen is measured, and the target flow or relevant flow of oxygen is thereby determined and achieved from controlling the flow of the first oxygen rich gas, from a gaseous source of oxygen at a pre-determined concentration.

The person skilled in the art will determine the optimal concentration of oxygen in the gases entering the ammonia converter 37 and the absorption tower 41, in order for the catalytic conversion of ammonia to nitric oxide to proceed optimally in the ammonia converter 37 and for the absorption of NOₓ gases in the absorption tower 41 to proceed optimally. Further, upon determining the oxygen content exiting the absorption tower 41, he will also weigh out the benefits of increasing the oxygen content in the absorption tower 41, against the drawback of a higher gas volume downstream the absorption tower 41, which implies equipment, such as heat exchangers, of a larger size, for heating tail gas.

As defined herein, means for measuring the temperature are any means suitable for measuring and indicating the temperature in the ammonia oxidation burner. In particular, the means for measuring the temperature is a thermocouple or a thermometer suitable for measuring and indicating a temperature ranging as high as 1,000° C. More in particular, the means for measuring the temperature is an infrared thermometer for measuring and indicating a temperature ranging as high as 1,000° C.

### Examples

### 1. Recirculation of Tail-Gas at 99.3%

Reference is made to FIG. 2A. Ammonia 32 was mixed with pressurized air 65 in a mixing apparatus 35. The resulting ammonia/compressed air mixture 14 was fed to an ammonia converter 37, at a temperature ranging from 800 to 950° C. and operating at a pressure of 5.4 bara. The oxygen to ammonia mola ratio at the inlet of the ammonia converter 37 was at least 1.25. In the ammonia converter 37, ammonia was oxidized over a mixed platinum/rhodium catalyst, thus obtaining a low-pressure NOₓ gas/steam mixture 15, comprising water and nitric oxide (NO). The heat of the mixture coming out of the ammonia converter was recovered, thereby producing steam that was supplied to a steam turbine 51 and that was also exported to a grid and used for heating the tail gas 5 as will be described below. The NOₓ gas/stream mixture was subsequently cooled down in a gas cooler/condenser 38 to a temperature where the water condenses, and an aqueous diluted nitric acid mixture 17 was separated from a gaseous NOₓ stream 22. The aqueous diluted acid mixture 17 was sent to the absorption tower 41. The gaseous NOₓ stream 22 was further oxidized to further convert the NO to NO₂ and N₂O₄. The gaseous NOₓ stream 22 then was compressed in the NOₓ gas compressor 40 to a pressure of 12 bara, thereby producing the pressurized NOₓ gaseous stream 24. The pressurized NOₓ gaseous stream 24 was cooled down in a second gas cooler/condenser 39 and sent to the absorption tower 41 too. Inside the absorption tower 41, the NOₓ gas reacted with water to produce the tail gas 5 and a stream of raw nitric acid also containing residual NOₓ gas, which was subsequently fed to a bleacher 62. The oxygen content in the tail gas 5 was maintained at 3% using the off-gases 77 from a bleacher 62 which were supplied downstream the ammonia converter 37 and upstream the NOₓ gas compressor 40. The tail gas 5 was consecutively heated in a heat exchanger 79, treated in a De-NOₓ unit 70, and heated by the gaseous NOₓ stream 15 in the heat exchange system 43 to 500° C., thereby producing a heated tail gas stream. The heated tail gas stream was expanded over a tail gas expander 7, thereby producing an expanded tail gas 64. The expanded tail gas 64 was used for heating the tail gas 5 in the heat exchanger 7 and was subsequently split, over a T-tube 55, into a first tail gas stream 10 representing 99.3% of the expanded tail gas 64, and a second tail gas stream 80. The first tail gas 10 was then mixed with oxygen-rich gas 50 having a pressure of 7 bara, thereby providing an oxygen-containing gas 56 in the absence of further pressurized air 34 being supplied, such that, during further continuous operation, tail gas 5 was produced, in the absence of an air compressor, heated, expanded and split and recirculated to the ammonia converter 37, together with an oxygen-rich gas 50. The amount of the oxygen-rich gas 50 fed to the process was controlled in order to ensure that the oxygen to ammonia ratio at the inlet of the ammonia converter 37 was measured and, in case it was lower than 1.25, the amount of the oxygen-rich gas 50 was adjusted, such that the oxygen to ammonia molar ratio at the inlet of the ammonia converter 37 was at least 1.25. The temperature inside the ammonia converter 37 was measured and established to have remained in the range of 800 to 950° C. The residual 0.7% of second tail gas stream 80 was sent to an additional tail gas expander 60. The residual NOₓ gas in the raw nitric acid stream 27 was then stripped out with a gaseous medium 72 such as an oxygen-containing gas or air, inside the bleacher unit 62, operating at about the same pressure as the ammonia converter of 5.4 bara. The drive power for both the air compressor 36 and the NOₓ compressor 40 originated from the tail gas expander 7, the additional tail gas expander 60 and the steam turbine 51. The net power associated to the NOₓ gas compressor 40, the tail gas expander 7 and the additional tail gas expander 60 was 8 kWh/t 100% HNO₃. This power was produced by the steam turbine 51 or was provided by an electrical motor. The specific steam export amounted to 1100 to 1300 kg/t nitric acid.

### 2. Comparative Example: No Recirculation of Tail-Gas

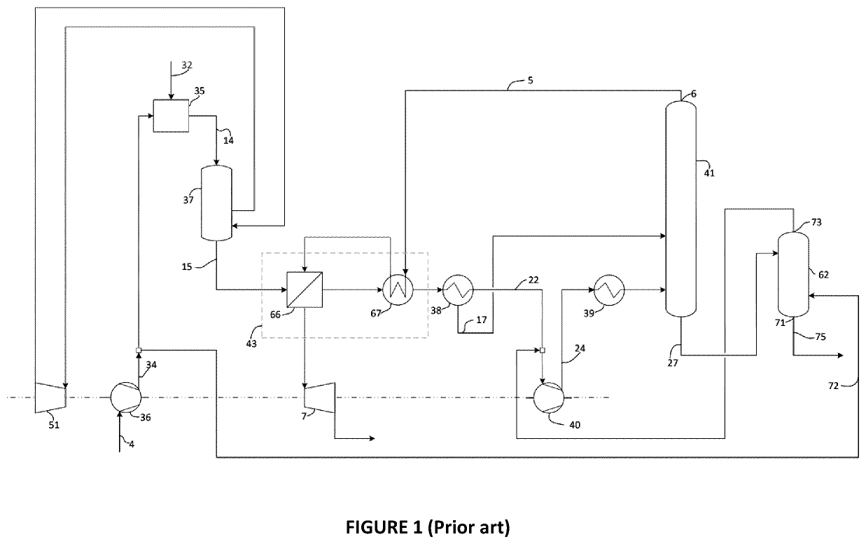

Reference is made to FIG. 1. Ammonia 32 was mixed with compressed air 34 in a mixing apparatus 35. The oxygen to ammonia ratio at the inlet of the ammonia converter 37 was at least 1.25. In the ammonia converter 37, the ammonia in the mixture of ammonia 32 and compressed air 34 was oxidized, at a pressure of 5.4 bara, over a mixed platinum/rhodium catalyst, thus obtaining a low-pressure NOₓ gas/steam mixture 15, comprising water and nitric oxide (NO). The heat of the mixture coming out of the ammonia converter was recovered for supplying the steam turbine 51 and was also exported to a grid and used for heating the tail gas 5 as will be described below. The NOₓ gas/stream mixture was subsequently cooled down in a gas cooler/condenser 38 to a temperature where the water condenses, and an aqueous diluted nitric acid mixture 17 was separated from a gaseous NOₓ stream 22. Subsequently, the gaseous NOₓ stream 22 was consecutively further oxidized to further convert the NO to NO₂ and N₂O₄, cooled down again in another gas cooler/condenser 39, and then directed to an absorption tower 41. On the other end, the gaseous NOₓ stream 22 was compressed in the NOₓ gas compressor 40 to a pressure of 12 bara, thereby producing the pressurized NOₓ gaseous stream 24. The pressurized NOₓ gaseous stream 24 was sent to the absorption tower 41 too. Inside the absorption tower 41, the NOₓ gaseous stream 24 reacted with water to produce the tail gas 5 and a stream of raw nitric acid 27 also containing residual NOₓ gas, which was fed to a bleacher 62. The heat from the gaseous NOₓ stream 15 was used for heating the tail gas 5 in the heat exchange system 43 to 450° C. The entire tail gas stream 5 was sent to the tail gas expander 7. The residual NOₓ gas in the raw nitric acid stream 27 was then stripped out with a gaseous medium 72 such as an oxygen-containing gas or air, inside the bleacher unit 62, operating at 5.4 bara. The drive power for the air compressor 36 and the NOₓ compressor 40 originated from the tail gas expander 7 and the steam turbine 51. This power was produced by the steam turbine 51. The specific steam export amounted to 600 to 800 kg/t nitric acid.

1. A production plant for producing nitric acid at reduced power consumption and reduced emissions, comprising:
a source of pressurized oxygen-rich gas;
a mixing apparatus downstream the source of oxygen-rich gas, for mixing a first oxygen-containing gas with an ammonia gas stream, to produce an ammonia/oxygen-containing gas mixture;
an ammonia converter operable at a pressure equal to or higher than P1 and lower than P2, for oxidizing ammonia in the ammonia/oxygen-containing gas mixture, to produce a NOₓ gas/steam mixture comprising water and nitric oxide
a means for regulating a concentration of ammonia and/or of oxygen in the ammonia converter, including a means for controlling a flow of the oxygen-rich gas and/or a means for controlling a flow of the ammonia gas stream, for maintaining the oxygen to ammonia molar ratio inside the ammonia converter at a ratio of at least 1.2;
a first gas cooler/condenser downstream the ammonia converter, to produce an aqueous diluted nitric acid mixture and a gaseous NOₓ stream;
a NOₓ gas compressor for compressing the gaseous NOₓ stream, to produce a compressed NOₓ gas stream at a pressure P2;
an absorption tower for absorbing NOₓ gases from the compressed NOₓ gas stream in water, to produce a stream of raw nitric acid containing residual NOₓ gas, and a tail gas comprising NOₓ gases, comprising an absorption tower tail gas outlet for evacuating the tail gas;
a heat exchange system located upstream the gas cooler/condenser for exchanging heat between the NOₓ gas/steam mixture and the tail gas for heating a tail gas stream with the heat from the NOₓ gas/steam coming from the ammonia converter;
a second gas cooler/condenser for separating and condensing steam from the compressed NOₓ gas stream before the compressed NOx gas stream is provided to the absorption tower;
a supply for a second oxygen-containing gas having either (i) a pressure equal to or higher than P1 and up to Pc, for supplying oxygen downstream the ammonia converter and upstream the NOₓ gas compressor, or (ii) a pressure higher than P2, for supplying oxygen to the compressed NOₓ gas stream,
a means for controlling the flow of the second oxygen-containing gas, such that a tail gas stream contains at least 0.5% by volume oxygen; and
a first pressure release means located downstream the heat exchange system, for expanding a stream of tail gas downstream the absorption tower, to produce a first expanded tail gas at a pressure equal to or higher than P1 and lower than P2, wherein the first pressure release means can at least partly power the NOₓ gas compressor;
characterized in that the production plant further comprises:
a means for splitting a tail gas into a first tail gas stream and a second tail gas stream, wherein the first tail gas is in fluid communication with the oxygen-rich gas, wherein the first tail gas stream has a pressure equal to or higher than P1 and up to P2, and wherein the mixing of the oxygen-rich gas and the first tail gas stream provides the first oxygen-containing gas; and

2. A production plant for producing nitric acid according to claim 1, comprising a source of pressurized air for pressurizing the system during startup, in fluid communication with a system comprising:
a source of a pressurized oxygen-rich gas;
a mixing apparatus downstream the source of the oxygen-rich gas, for mixing a first oxygen-containing gas with an ammonia gas stream, to produce an ammonia/oxygen-containing gas mixture;
means for measuring the oxygen concentration in the first oxygen-containing gas;
means for adjusting the concentration of oxygen in the first oxygen-containing gas such that the oxygen to ammonia molar ratio at an inlet of the ammonia converter is at least 1.2;
means for adjusting the supply of the ammonia gas stream to the mixing apparatus;
an ammonia converter, operable at a pressure P1, for oxidising ammonia in the ammonia/oxygen-containing gas mixture, to produce a NOₓ gas/steam mixture, comprising water and nitric oxide;
means for measuring a temperature in the ammonia converter;
a first gas cooler/condenser downstream the ammonia converter-, to produce an aqueous diluted nitric acid mixture and a gaseous NOₓ stream;
a NOₓ gas compressor for compressing the gaseous NOₓ stream, to produce a compressed NOs gas stream at a pressure P2;
an absorption tower for absorbing the NOₓ gases from the compressed NOₓ gas stream in water, to produce a stream of raw nitric acid-containing residual NOₓ gas and a tail gas comprising NOₓ gases, comprising an absorption tower tail gas outlet for evacuating the tail gas;
means for measuring the concentration of oxygen in a tail gas stream downstream the absorption tower;
a heat exchange system located upstream the gas cooler/condenser for exchanging heat between the NOₓ gas/steam mixture and the tail gas;
a second additional gas cooler/condenser, for separating and condensing steam from the compressed NOₓ gas stream, to produce a compressed NOₓ-gas stream;
a supply of a second oxygen-containing gas having either (i) a pressure equal to or higher than P1 and up to P2, for supplying oxygen upstream the NOₓ gas compressor; or a pressure higher than P2, for supplying oxygen to the compressed NOₓ gas stream, such that the tail gas contains at least 0.5% by volume oxygen; and
a tail gas expander located downstream the heat exchange system, for expanding a stream of tail gas downstream the absorption tower, to produce a first expanded tail gas at a pressure P1, wherein the tail gas expander can at least partly power the NOₓ gas compressor;
characterized in that the system further comprises:
a means for splitting a stream of tail gas downstream the absorption tower into a first tail gas stream, in fluid communication with the oxygen-rich gas and a second tail gas stream; and
a means for adjusting an amount of tail gas being split into the first tail gas stream and the second tail gas stream.

3. The production plant according to claim 1, wherein the system further comprises one or more of:
a steam turbine, wherein the steam turbine can at least partly power the NOₓ gas compressor;
a heat exchanger for exchanging heat between the first expanded tail gas and a colder tail gas stream, wherein the first expanded tail gas exits the heat exchanger at a temperature below 300° C., and wherein the means for splitting is positioned downstream the heat exchanger and in fluid communication with the first expanded tail gas;
a De-NOₓ treatment unit; and
a second pressure release means for expanding the second tail gas stream to atmospheric pressure, to produce a second expanded tail gas.

4. The production plant according to claim 1, further comprising a bleacher for bleaching the stream of raw nitric acid-containing residual NOₓ gas, to provide a stream of bleached nitric acid, having an inlet for an oxygen-rich bleaching gas, and an outlet for off-gases in fluid communication with any gas stream downstream the ammonia converter and upstream the NOₓ gas compressor if the bleacher operates at a pressure equal to or higher than P1 and up to equal to P2, or in fluid communication with any stream downstream the NOₓ gas compressor and upstream the absorption tower if the bleacher operates at a pressure higher than P2, such that the supply for the second oxygen containing gas comes at least partly from the off-gases.

5. The production plant according to claim 4, wherein part of the oxygen-rich gas or part of the first oxygen-containing gas or part of the tail gas, is in fluid communication with the inlet of the bleacher, such that the oxygen-rich bleaching gas is at least partly provided by part of the oxygen-rich gas by part of the first oxygen-containing gas or by part of a tail gas stream.

6. The production plant according to claim 1, further comprising a stream of a second oxygen-containing gas in direct fluid communication with a stream of pressurized oxygen-rich gas in direct fluid communication with any stream of tail gas downstream the absorption tower or upstream the first pressure release means.

7. The production plant according to claim 4, wherein the oxygen-rich gas, the second oxygen-containing gas, the oxygen-rich bleaching gas and the bleacher off-gases are all at least partly provided by a high pressure water electrolyzer.

8. The production plant according to claim 1, wherein the fluid communication between the source of pressurized air and the system is in direct fluid communication with the oxygen-rich gas.

9. A method for producing nitric acid at reduced power consumption and reduced emissions, in a production plant according to claim 1, comprising the steps of:
prior to step c), providing or preparing an oxygen-rich gas and a first oxygen-containing gas, and providing an ammonia gas stream;
c) supplying the ammonia gas stream and a first oxygen-containing gas to the mixing apparatus, thereby producing the ammonia/oxygen-containing gas mixture;
d) oxidising ammonia in the ammonia/oxygen-containing gas mixture in the ammonia converter, thereby producing the gaseous NOx gas/steam mixture, comprising water and nitric oxide;
e) cooling the NOₓ gas in the gaseous NOₓ gas/steam mixture in the heat exchange system and in a first gas/cooler condenser, thereby producing an aqueous diluted nitric acid mixture and a gaseous NOₓ stream;
f) compressing the gaseous NOₓ stream in the NOₓ gas compressor, thereby providing the pressurized NOₓ compressed gas stream having a pressure P2;
g) absorbing the pressurized gaseous NOₓ stream in the absorption tower, thereby providing the stream of raw nitric acid-containing residual NOₓ gas and the tail gas comprising NOₓ gases;
h) heating the tail gas in the heat exchange system, with the heat from the NOₓ gas/steam mixture coming from the ammonia converter;
i) cooling the pressurized NOₓ gas stream in a second gas cooler/condenser, thereby providing a pressurized NOₓ gas stream; and
j) expanding at least part of the tail gas obtained in step h) in a first pressure release means, thereby providing a first expanded tail gas;
characterized in that the method further comprises steps of:
k) splitting a tail gas stream with a first means for splitting into a first tail gas stream and a second tail gas stream, and mixing the first tail gas stream with the oxygen-rich gas, thereby providing the first oxygen-containing gas;
m) adjusting the flow of the oxygen-rich gas being mixed in step k) or the flow of the ammonia gas stream, such that the oxygen to ammonia molar ratio at an inlet of the ammonia converter is maintained to a ratio of at least 1.2; and
q) adjusting the flow of the oxygen-rich gas at a pressure equal to or higher than P1 and up to P2 upstream the NOₓ gas compressor, or at a pressure higher than P2 downstream the NOₓ gas compressor, such that the oxygen concentration in a tail gas stream is maintained at a concentration of at least 0.5% by volume;

10. A method for producing nitric acid at reduced power consumption and reduced emissions according to claim 9, comprising steps of:
a) pressurizing the system by supplying pressurized air in the system;
b) operating the NOₓ gas compressor or a first pressure release means using external power, thereby inducing a pressurized air flow in the system and a pressure P2, downstream the NOₓ gas compressor;
c) supplying the ammonia gas stream and a first oxygen containing gas to the mixing apparatus, thereby producing the ammonia/oxygen-containing gas mixture;
d) oxidising ammonia in the ammonia/oxygen-containing gas mixture in the ammonia converter thereby producing the gaseous NOₓ gas/steam mixture, comprising water and nitric oxide;
e) cooling the NOₓ-gas in the gaseous NOₓ gas/steam mixture in the heat exchange system and in the first gas/cooler condenser, thereby producing an aqueous diluted nitric acid mixture and a gaseous NOₓ stream;
f) compressing the gaseous NOₓ stream in the NOₓ gas compressor, thereby providing the pressurized NOₓ compressed gas stream having a pressure P2;
g) absorbing the pressurized gaseous NOₓ stream in the absorption tower, thereby providing the stream of raw nitric acid-containing residual NOₓ gas and the tail gas comprising NOₓ gases;
h) heating the tail gas in the heat exchange system, with the heat from the NOₓ gas/steam mixture coming from the ammonia converter;
i) cooling the pressurized NOₓ gas stream in the second gas cooler/condenser, thereby providing a pressurized NOₓ gas stream; and
j) expanding the tail gas obtained in step h) in the tail gas expander, thereby providing the first expanded tail gas;
characterized in that the method further comprises steps of:
k) splitting a tail gas stream with a means for splitting into a first tail gas stream and a second tail gas stream and mixing the first tail gas stream with the oxygen-rich gas, thereby providing the oxygen-containing gas;
l) measuring the oxygen concentration in the oxygen-containing gas;
m) if the oxygen concentration measured in step l) is such that the oxygen to ammonia molar ratio in the ammonia converter is less than 1.2, adjusting the supply of the oxygen-rich gas, for instance having a pressure P2, and being mixed in step k) or adjusting the supply of the ammonia gas stream in step c), such that the oxygen to ammonia molar ratio at the inlet of the ammonia converter is at least 1.2;
n) measuring a temperature in the ammonia converter;
o) adjusting the volume of the first tail gas stream being mixed in step k) or the ammonia gas stream supplied in step c), if the temperature measured in step n) is outside a range of 800-950-° C., such that the temperature in the ammonia converter is maintained in the range of 800-950-° C.;
p) measuring the oxygen concentration in a tail gas downstream the absorption tower;
q) if the oxygen concentration measured in step p) is less 0.5% by volume oxygen, adjusting the supply of the oxygen-rich gas at a pressure equal to or higher than P1 and up to P2 upstream the NOₓ gas compressor, or at a pressure higher than P2 downstream the NOₓ gas compressor, or adjusting the flow of the second oxygen-containing gas, such that the tail gas contains at least 0.5% by volume oxygen;
r) repeating steps c) to q).

11. The method according to claim 9, wherein, the first tail gas stream mixed in step k) is obtained after step j), and wherein the method further comprises steps of:
s) before step k), heating up, in the heat exchanger, a tail gas stream that is colder than the first expanded tail gas with the first expanded tail gas, thereby bringing the first expanded tail gas to a temperature below 300° C. before step k), heating up, in the heat exchanger the tail gas obtained in step g) with the first expanded tail gas obtained in step j), thereby bringing the tail gas to be mixed in step k) to a temperature below 300-° C.;
t) treating the tail gas stream, obtained in step s, in a De-NOₓ treatment unit;
u) expanding the second tail gas stream in the second pressure release means, thereby providing the second expanded tail gas; and
v) recovering at least part of the steam generated in the ammonia converter in a steam turbine.

12. The method according to claim 9,
further comprising a step of:
w) bleaching the stream of raw nitric acid-containing residual NOₓ gas in a bleacher, thereby producing the stream of bleached nitric acid.

13. The method according to claim 12, further comprising a step of:
w1) supplying part of the oxygen-rich or part of the first oxygen-containing gas obtained in step k) or part of the tail gas obtained in step g), to the inlet of the bleacher in step w).

14. The method according to claim 9,
further comprising a step of:
x) supplying a stream of a pressurized oxygen-rich gas, to a tail gas stream upstream the first pressure release means.

15. The method according to claim 9, further comprising steps of:
y) operating a high pressure water electrolyzer, thereby producing pressurized oxygen gas; and
z) providing, from the oxygen produced by the water electrolyzer in step y), at least part of the oxygen-rich gas, the second oxygen containing gas, oxygen-rich bleaching gas, and bleacher off gases.

16. The method according to claim 10, wherein, in step a), the pressurized air is supplied in the stream in direct fluid communication with the oxygen-rich gas.

17. (canceled)

18. A method for revamping an existing production plant for producing nitric acid, wherein the existing production plant comprises:
an air compressor for providing a compressed air stream;
a mixing apparatus, for mixing the compressed air stream with an ammonia gas stream, to produce an ammonia/oxygen-containing gas mixture;
an ammonia converter operable at a pressure equal to or higher than P1 but lower than P2, for oxidising ammonia in the ammonia/oxygen-containing gas mixture, to produce a NOₓ gas/steam mixture, comprising water and nitric oxide;
a first gas cooler/condenser, downstream the ammonia converter, to produce an aqueous diluted nitric acid mixture, and a gaseous NOₓ stream;
a NOₓ gas compressor for compressing the gaseous NOₓ stream, to produce a pressurized NOₓ gas stream at a pressure P2;
an absorption tower for absorbing the NOₓ gases from the pressurized NOₓ gas stream in water, to produce a stream of raw nitric acid-containing residual NOₓ gas and a tail gas comprising NOₓ gases;
a heat exchange system for exchanging heat between the NOₓ gas/steam mixture and the tail gas for heating a tail gas stream with the heat from the NOₓ gas/steam mixture from the ammonia converter;
a second gas cooler/condenser for separating and condensing steam from the compressed NOₓ gas stream between the NOₓ compressor and the absorption tower, and
a tail gas expander for expanding a stream of tail gas downstream the absorption tower, to produce an expanded tail gas at a pressure P1, wherein the tail gas expander can at least partly power the NOₓ gas compressor
into a production plant according to claim 1, comprising steps of:
introducing a source of pressurized air in fluid communication with the production plant;
introducing a supply or source of an oxygen-rich gas providing part of a first oxygen-containing gas, upstream of and in fluid communication with the mixing apparatus;
introducing a means for regulating the concentration of ammonia and/or oxygen in the ammonia converter, including a means for controlling the flow of the oxygen-rich gas or the flow of the first oxygen-containing gas and/or a means for controlling the flow of the ammonia gas stream, for maintaining the oxygen to ammonia molar ratio inside the ammonia converter at a ratio of at least 1.2;
introducing a supply of a second oxygen-containing gas, having either (i) a pressure equal to or higher than P1 and up to P2 for supplying oxygen upstream the NOₓ gas compressor, or (ii) a pressure higher than P2, for supplying oxygen to the compressed NOₓ gas stream, such that a tail gas stream contains at least 0.5% by volume of oxygen;
introducing means for splitting a stream of tail gas into a first tail gas stream and a second tail gas stream, wherein the first tail gas stream has a pressure equal to or higher than P1 and up to P2, and is in fluid communication with the oxygen-rich gas, which, upon mixing with the oxygen-rich gas provides the first oxygen-containing gas;
introducing means for adjusting an amount of tail gas being split into the first tail gas stream and the second tail gas stream; and
removing the air compressor.

19. The method according to claim 18, wherein the supply or source of an oxygen-rich gas is a high pressure water electrolyzer.

20. The production plant according to claim 1, wherein the first pressure release means is a tail gas expander.

21. The method according to claim 9, wherein the oxygen to ammonia molar ratio is between 1.2 and 1.9.

22. The method according to claim 9, wherein the NOₓ gas stream has a temperature ranging from 20 to 60° C.

23. The method according to claim 9, wherein ammonia is oxidized in the ammonia/oxygen-containing gas mixture in the ammonia converter at a pressure equal to or higher than P1 and lower than P2 and at a temperature ranging from 800 to 950° C.

24. The method according to claim 9, wherein the tail gas is heated in the heat exchange system to a temperature ranging from 150 to 650° C.

25. The method according to claim 9, wherein the pressurized NOₓ gas stream has a temperature ranging from 20 to 60° C.

26. The method according to claim 10, wherein the ammonia is oxidized in the ammonia/oxygen-containing gas mixture in the ammonia converter at a pressure P1 and a temperature ranging from 800 to 950° C.

27. The method according to claim 10, wherein the oxygen to ammonia molar ratio is between 1.2 and 1.9 the first pressure means is a tail gas expander.

28. The method according to claim 10, wherein the tail gas is heated in the heat exchange system to a temperature ranging from 150 to 650° C.
